(19) United States
(12) Patent Application Publication
(10) Pub. No.: US 2026/0125303 A1
(43) Pub. Date: May 7, 2026

(54) SUSTAINABLE DESALINATION PLANT AND SUSTAINABLE METHOD FOR THE DESALINATION OF WATER

(71) Applicant: IDE WATER TECHNOLOGIES LTD., Kadima (IL)

(72) Inventors: Alex DRAK, Kadima (IL); Tomer EFRAT, Kadima (IL)

(21) Appl. No.: 19/117,950

(22) PCT Filed: Oct. 4, 2023
(86) PCT No.: PCT/US2023/034443

§ 371 Date: Apr. 2, 2025

(30) Foreign Application Priority Data
Oct. 5, 2022 (IL) 297088

(51) Int. Cl. C02F 9/00; B01D 61/02; B01D 61/04; C01B 32/50; C01F 11/02; C01F 11/18; C02F 1/44; C02F 1/52; C02F 1/66; C02F 1/68; C02F 101/10; C02F 103/08

(52) U.S. Cl. CPC C02F 9/00; B01D 61/025; B01D 61/04; C01B 32/50; C01F 11/02; C01F 11/18; C02F 1/441; C02F 1/5245; C02F 1/66; C02F 1/68; C02F 2101/10; C02F 2103/08; C02F 2301/043

(57) ABSTRACT

Some embodiments relate to a sea water desalination process and plant that reacts the input sea water with calcium hydroxide 2 prior to its passage through a reverse osmosis pass 8 to precipitate calcium carbonate and increase the alkalinity of the water prior to its desalination. The calcium carbonate is converted in a regenerator 10 to produce calcium hydroxide and carbon dioxide. This provides for a series of benefits in the overall cost efficiency and sustainability of the process/plant.

### CROSS-REFERENCE TO RELATED APPLICATIONS

This application is a national phase filing under 35 C.F.R. § 371 of and claims priority to PCT Patent Application No. PCT/US2023/034443, filed on Oct. 4, 2023, which claims the priority benefit under 35 U.S.C. § 119 of Israeli Patent Application No. 297088, filed on Oct. 5, 2022, the contents of which are hereby incorporated in their entireties by reference.

### FIELD OF THE DISCLOSURE

The presently disclosed subject matter relates generally to a more environmentally sustainable production of desalinated water and to a sustainable desalination plant.

### BACKGROUND

Desalination is a process that removes mineral components from sea water to provide water that is suitable for human consumption or irrigation. The by-product of the desalination process is brine, a super concentrated solution. A conventional seawater desalination plant delivers sea water, via an intake channel, through various pre-treatment sites such as filters before being pumped under pressure through multiple reverse osmosis passes to form desalinated product water and concentrated sea water or brine. During this process, other minerals in addition to salt are removed from the water which must be re-introduced to provide an acceptable product water and therefore the water is also subjected to post-treatments, such as pH adjustment and the addition of minerals such as magnesium before being held in a holding tank for later consumption. The brine may be discharged back into the sea via a discharge channel or subjected to a further desalination process to create additional product water.

Conventional desalination processes and plants may include a single pass (as shown in FIG. 1) or a double pass (see FIG. 2), depending upon the required product water quality. One desalination process and system operated by the Applicant, IDE

Technologies, is the two-pass concept as shown in FIG. 2 where sea water is delivered through an intake channel through a filtration module to a clearwell from which it is passed through a first sea water reverse osmosis pass (SWRO) with the brine then passing through a brackish water reverse osmosis (BWRO) pass. The combined permeate from both passes is then treated to provide final product water quality. This process and system use chemicals which are both very costly and affect the sustainability level of the process/plant.

In the current two-pass SWRO process as shown in FIG. 1 the main chemicals used for operation are sodium hydroxide (NaOH), sulphuric acid (H₂SO₄), calcium carbonate (CaCO₃) and carbon dioxide (CO₂). The sodium hydroxide and sulphuric acid are used for boron rejection in the BWRO pass while calcium carbonate and carbon dioxide are used for final product remineralization in the post treatment stage. The cost of these chemicals is significant. It is desirable to improve this process to substantially reduce the total cost of the chemicals. Moreover, it would be advantageous to provide a self-sustainable desalination process/plant, or at least one that is partially self-sustainable, to self-produce the required chemicals for its own operation.

It is an object of the presently disclosed subject matter to provide an improved desalination process and system that aims to address this issue.

### SUMMARY OF THE DISCLOSURE

It is one object of the presently disclosed subject matter to provide a process for the desalination of sea water, the process comprising:
feeding at least a portion of intake sea water through at least one reactor for the removal of carbonates-based chemical; and
filtrating said intake sea water.

It is another object of the presently disclosed subject matter to provide the process as defined above, wherein said step of filtrating comprising desalinating said intake sea water to produce permeate product water and brine.

It is another object of the presently disclosed subject matter to provide the process as defined above, wherein said step of filtrating comprising at least one process selected from a group consisting of reverse osmosis, forward osmosis, pressure-retarded osmosis, ultrafiltration, microfiltration and nanofiltration any combination thereof.

It is another object of the presently disclosed subject matter to provide the process as defined above, wherein the reactor containing therein or is introduced with at least one selected from a group consisting calcium hydroxide (Ca(OH)₂), NaOH and any combination thereof to precipitate at least one carbonates-based chemical selected from a group consisting of calcium carbonate (CaCO₃).

It is another object of the presently disclosed subject matter to provide the process as defined above, wherein the reactor containing therein or is introduced with at least one selected from a group consisting calcium hydroxide (Ca(OH)₂), NaOH and any combination thereof to precipitate at least one carbonates-based chemical selected from a group consisting of calcium carbonate (CaCO₃), according to the following formula: Ca(OH)2+Ca(HCO3)2->2CaCO3+2H2O.

It is another object of the presently disclosed subject matter to provide the process as defined above, further comprising introducing calcium hydroxide (Ca(OH)₂) into the at least one reactor.

It is another object of the presently disclosed subject matter to provide the process as defined above, wherein feeding at least a portion of intake sea water through at least one reactor containing calcium hydroxide (Ca(OH)₂) increases the pH of the intake water to at least pH 8.3.

It is another object of the presently disclosed subject matter to provide the process as defined above, wherein desalinating said intake sea water comprises delivering the intake water to at least one pass comprising at least one reverse osmosis membrane to produce the permeate water and brine.

It is another object of the presently disclosed subject matter to provide the process as defined above, further comprising the step of regenerating at least some of the calcium carbonate precipitant to a calcium-based chemical and carbon dioxide.

It is another object of the presently disclosed subject matter to provide the process as defined above, wherein the calcium-based chemical is selected from a group consisting of calcium hydroxide or calcium oxide and any combination thereof.

It is another object of the presently disclosed subject matter to provide the process as defined above, wherein regenerating the calcium carbonate to the calcium-based chemical comprises a method selected from at least one of calcinating the precipitated calcium carbonate, hydrolysing the precipitated calcium carbonate and any combination thereof.

It is another object of the presently disclosed subject matter to provide the process as defined above, wherein regenerating the calcium carbonate comprises calcination comprising heating the calcium carbonate to a temperature of at least 500° C.

It is another object of the presently disclosed subject matter to provide the process as defined above, wherein regenerating the calcium carbonate comprises hydrolysing the calcium carbonate to produce at least one selected from the group consisting of calcium hydroxide, calcium oxide, carbon dioxide and any combination thereof.

It is another object of the presently disclosed subject matter to provide the process as defined above, wherein said step of hydrolysis of the calcium carbonate is performed at a temperature of less than 500° C.

It is another object of the presently disclosed subject matter to provide the process as defined above, wherein the calcium-based chemical is calcium oxide and the process further comprises mixing at least a portion of the calcium oxide with at least a portion of intake sea water to form calcium hydroxide.

It is another object of the presently disclosed subject matter to provide the process as defined above, wherein at least a portion of the calcium hydroxide formed by regeneration of the calcium carbonate is at least one selected from (a) recycled for use in the at least one reactor; (b) used in the post treatment process; (c) any combination thereof.

It is another object of the presently disclosed subject matter to provide the process as defined above, wherein additionally comprising at least one step selected from a group consisting of (a) feeding at least a portion of intake sea water through the at least one reactor containing calcium hydroxide (Ca(OH)₂) also precipitates magnesium hydroxide; (b) feeding at least a portion of intake sea water through the at least one second reactor adapted to precipitate magnesium-based chemical selected from a group consisting of magnesium hydroxide, magnesium oxide and any combination thereof; and any combination thereof.

It is another object of the presently disclosed subject matter to provide the process as defined above, further comprising the step of regenerating at least some of the magnesium hydroxide precipitant to a magnesium-based chemical.

It is another object of the presently disclosed subject matter to provide the process as defined above, further comprising adding at least a portion of the regenerated magnesium-based chemical to the permeate to produce product water.

It is another object of the presently disclosed subject matter to provide the process as defined above, wherein feeding at least a portion of intake sea water through the at least one reactor containing calcium hydroxide (Ca(OH)₂) also precipitates magnesium hydroxide; and the process further comprises the steps of (i) regenerating at least some of the calcium carbonate and magnesium hydroxide precipitants to produce a calcium-based chemical, a magnesium-based chemical and carbon dioxide; and, (ii) mixing at least some of the regenerated chemicals and carbon dioxide with the permeate product water to produce drinking water.

It is another object of the presently disclosed subject matter to provide the process as defined above, wherein only a portion of the sea water is fed through the reactor with the remaining intake sea water bypassing the at least one reactor.

It is another object of the presently disclosed subject matter to provide the process as defined above, further comprising step of mixing said portion of the sea water fed through the at least one reactor with the remaining intake sea water bypassing the at least one reactor.

It is another object of the presently disclosed subject matter to provide the process as defined above, further comprising delivering at least a portion of the sea water to at least one of a filter unit and a clearwell.

It is another object of the presently disclosed subject matter to provide the process as defined above, further comprising passing at least a portion of the permeate from the reverse osmosis membranes of a first pass to a second pass of brackish water reverse osmosis.

It is another object of the presently disclosed subject matter to provide the process as defined above, further comprising adding at least one of sodium hydroxide or calcium hydroxide to the permeate prior to its introduction to the second pass.

It is another object of the presently disclosed subject matter to provide the process as defined above, further comprising regenerating the calcium hydroxide from the calcium carbonate precipitant and adding at least a portion of the regenerated calcium hydroxide to the permeate prior to its introduction to the second pass.

It is another object of the presently disclosed subject matter to provide the process as defined above, wherein the process excludes calcium carbonate contactor in the post-treatment of the permeate water.

It is another object of the presently disclosed subject matter to provide the process as defined above, wherein at least a portion of the calcium carbonate, (CaCO₃), is used in the post treatments of the permeate water post the desalination step.

It is another object of the presently disclosed subject matter to provide the process as defined above, wherein at least a portion of the magnesium-based is used in the post treatments of the permeate water post the desalination step.

It is another object of the presently disclosed subject matter to provide a filtration system comprising:
at least one conduit for delivering at least a portion of an intake sea water to the at least one reactor for the removal of carbonates-based chemical; and
at least one filtrating module; wherein at least a portion of the intake sea water is delivered through the at least one reactor prior to being delivered through the filtrating module.

It is another object of the presently disclosed subject matter to provide the filtration system as defined above, wherein said at least one filtrating module is reverse osmosis pass comprising at least one reverse osmosis membrane; further wherein at least a portion of the intake sea water is delivered through the at least one reactor prior to being delivered through the pass to produce permeate product water and brine.

It is another object of the presently disclosed subject matter to provide the filtration system as defined above, wherein said at least one filtrating module comprising at least one process selected from a group consisting of reverse osmosis, forward osmosis, pressure-retarded osmosis, ultrafiltration, microfiltration and nanofiltration any combination thereof.

It is another object of the presently disclosed subject matter to provide the filtration system as defined above, wherein said at least one reactor having at least one calcium hydroxide (Ca(OH)₂), NaOH and any combination thereof source to precipitate at least one carbonates-based chemical selected from a group consisting of calcium carbonate (CaCO₃).

It is another object of the presently disclosed subject matter to provide the filtration system as defined above, wherein the reactor containing therein or is introduced with at least one selected from a group consisting calcium hydroxide (Ca(OH)₂), NaOH and any combination thereof to precipitate at least one carbonates-based chemical selected from a group consisting of calcium carbonate (CaCO₃), according to the following formula: Ca(OH)₂+Ca(HCO3)2->2CaCO3+2H2O.

It is another object of the presently disclosed subject matter to provide the filtration system as defined above, wherein at least one regeneration module is provided to convert at least some of the calcium carbonate precipitant to a calcium-based chemical and carbon dioxide.

It is another object of the presently disclosed subject matter to provide the filtration system as defined above, wherein said at least one regeneration module is selected from at least one of a calcinatory, a hydrolysis reactor and any combination thereof.

It is another object of the presently disclosed subject matter to provide the filtration system as defined above, wherein said at least one regeneration module is a calcinatory provided for calcinating the precipitated calcium carbonate to produce at least one of calcium hydroxide, calcium oxide, carbon dioxide and any combination thereof.

It is another object of the presently disclosed subject matter to provide the filtration system as defined above, wherein the calcinatory comprises a rotary kiln for calcination of the calcium carbonate.

It is another object of the presently disclosed subject matter to provide the filtration system as defined above, wherein the at least one regeneration module comprises at least one hydrolysis reactor for hydrolysing the calcium carbonate to produce at least one selected from a group consisting of calcium hydroxide (Ca(OH)₂), calcium oxide (CaO), carbon dioxide (CO₂) and any combination thereof.

It is another object of the presently disclosed subject matter to provide the filtration system as defined above, wherein said hydrolysis reactor operates at a temperature of less 500° C.

It is another object of the presently disclosed subject matter to provide the filtration system as defined above, wherein the calcinatory provided for calcinating the precipitated calcium carbonate produces calcium oxide and the system further comprises at least one mixing reactor adapted to mix at least a portion of the calcium oxide with at least a portion of the intake sea water to produce calcium hydroxide (Ca(OH)₂).

It is another object of the presently disclosed subject matter to provide the filtration system as defined above, wherein at least one pipe is provided to deliver at least one, preferably both, of a portion of the calcium-based chemical and carbon dioxide formed by the regeneration module to the permeate produced by the at least one reverse osmosis membrane to produce the product water.

It is another object of the presently disclosed subject matter to provide the filtration system as defined above, wherein at least one pipe is provided to recycle at least a portion of the calcium-based chemical formed by the regeneration module to the at least one reactor.

It is another object of the presently disclosed subject matter to provide the filtration system as defined above, wherein the at least one reactor also precipitates magnesium hydroxide from the intake sea water and at least one regeneration module is configured to regenerate at least some of the magnesium hydroxide precipitant to a magnesium-based chemical.

It is another object of the presently disclosed subject matter to provide the filtration system as defined above, further comprising at least one pipe to deliver at least a portion of the magnesium-based chemical formed by the regeneration module to the permeate produced by the at least one reverse osmosis membrane to produce drinking water.

It is another object of the presently disclosed subject matter to provide the filtration system as defined above, wherein the at least one reactor having a calcium hydroxide (Ca(OH)₂) source also precipitates magnesium hydroxide; and, the system includes at least one regeneration module regenerating at least some of the calcium carbonate and magnesium hydroxide precipitants to produce a calcium-based chemical, a magnesium-based chemical and carbon dioxide and piping to deliver at least some of the regenerated chemicals and carbon dioxide to the permeate product water to produce drinking water.

It is another object of the presently disclosed subject matter to provide the filtration system as defined above, wherein a bypass is provided between the intake sea water and the reverse osmosis pass to enable the delivery of a portion of the sea water through the at least one reactor with the remaining intake sea water bypassing the at least one reactor.

It is another object of the presently disclosed subject matter to provide the filtration system as defined above, wherein at least one of a filter unit and a clearwell is provided between the at least one reactor and the pass.

It is another object of the presently disclosed subject matter to provide the filtration system as defined above, wherein the at least one reactor is a fluidized bed reactor.

It is another object of the presently disclosed subject matter to provide the filtration system as defined above, wherein a second brackish water reverse osmosis pass is in fluid communication with the first pass, wherein at least a portion of the permeate from the first pass is delivered to the second pass.

It is another object of the presently disclosed subject matter to provide the filtration system as defined above, wherein at least one of a sodium hydroxide and calcium hydroxide source and any combination is provided between the first and second pass to introduce sodium hydroxide or calcium hydroxide to the permeate prior to its introduction to the second pass.

It is another object of the presently disclosed subject matter to provide the filtration system as defined above, wherein at least a portion of the intake sea water delivered through the at least one reactor results in an increase in pH of the at least a portion of the intake water to a pH of at least 8.3.

It is another object of the presently disclosed subject matter to provide the filtration system as defined above, wherein said increase in pH to at least 8.3 of at least a portion of the intake sea water enhances boron rejection by said at least one reverse osmosis membrane to thereby increase the overall efficiency of the desalination system.

It is another object of the presently disclosed subject matter to provide the filtration system as defined above, wherein at least a portion of the calcium carbonate, (CaCO₃), is used in the post treatments of the permeate water post the desalination step.

It is another object of the presently disclosed subject matter to provide the filtration system as defined above, wherein at least a portion of the magnesium-based is used in the post treatments of the permeate water post the desalination step.

It is another object of the presently disclosed subject matter to provide a self-sustainable desalination process for the desalination of sea water, the process comprising:
delivering sea water to an intake pipe;
carbonates-based chemical removing from said sea water;
delivering under pressure all the intake water to at least one pass comprising at least one reverse osmosis membrane to produce permeate and brine.

It is another object of the presently disclosed subject matter to provide the self-sustainable desalination process as defined abovCe, The self-sustainable desalination process according to claim 56, wherein said carbonates-based chemical removing is performed by introducing calcium hydroxide (Ca(OH)₂) into at least one reactor; and passing at least a portion of the intake sea water through the reactor to precipitate at least calcium carbonate (CaCO₃) from the sea water.

It is another object of the presently disclosed subject matter to provide the self-sustainable desalination process as defined above, additionally comprising step of regenerating at least one selected from the group consisting of calcium hydroxide (Ca(OH)₂), calcium oxide (CaO), carbon dioxide (CO₂), magnesium hydroxide (Mg(OH)₂) and any combination thereof.

It is another object of the presently disclosed subject matter to provide the self-sustainable desalination process as defined above, wherein said step of regenerating at least one selected from the group consisting of calcium hydroxide (Ca(OH)₂), calcium oxide (CaO), carbon dioxide (CO₂), magnesium hydroxide (Mg(OH)₂) and any combination thereof from said carbonates-based chemical.

It is another object of the presently disclosed subject matter to provide the self-sustainable desalination process as defined above, additionally comprising step of adding at least a portion of at least one of the calcium hydroxide (Ca(OH)₂), calcium oxide (CaO) and carbon dioxide (CO₂) and any combination thereof regenerated from the calcium carbonate (CaCO₃) precipitant to at least one of (i) the permeate to produce product water and (ii) the at least one reactor, and any combination thereof.

It is another object of the presently disclosed subject matter to a self-sustainable desalination system for the desalination of sea water, the system comprising:
a sea water intake;
at least one reactor having a calcium hydroxide (Ca(OH)₂) source;
at least one conduit for delivering at least a portion of the sea water from the intake to the at least one reactor to precipitate calcium carbonate (CaCO₃);
at least one reverse osmosis pass comprising at least one reverse osmosis membrane, wherein all the intake sea water is delivered through the pass to produce permeate and brine;
at least one regeneration module to convert at least some of the calcium carbonate (CaCO₃) precipitant to at least one selected from a group consisting of calcium hydroxide (Ca(OH)₂), calcium oxide (CaO), carbon dioxide (CO₂) and any combination thereof; and
a recycling system to deliver at least a portion of at least one of the calcium hydroxide (Ca(OH)₂), calcium oxide (CaO) and carbon dioxide (CO₂) and any combination thereof regenerated from the calcium carbonate (CaCO₃) precipitant to at least one of (i) the permeate to produce product water and (ii) the at least one reactor and any combination thereof.

It is another object of the presently disclosed subject matter to provide a calcium carbonate reactor-free post-treatment desalination method for the treatment of permeate water comprising step of adding at least one of calcium hydroxide (Ca(OH)₂), magnesium hydroxide (Mg(OH)₂) to intake sea water prior to desalinating the same, wherein said post-treatment desalination method is free of calcium carbonate reactor.

It is another object of the presently disclosed subject matter to provide the post-treatment method as defined above, wherein at least one of the calcium hydroxide (Ca(OH)₂), magnesium hydroxide (Mg(OH)₂) is regenerated calcium carbonate precipitated during said step of adding at least one of calcium hydroxide (Ca(OH)₂), magnesium hydroxide (Mg(OH)₂) to intake sea water.

It is another object of the presently disclosed subject matter to provide the post-treatment method as defined above, further comprising feeding at least a portion of intake sea water through at least one reactor, the reactor containing therein or is introduced with at least one selected from a group consisting calcium hydroxide (Ca(OH)₂), NaOH and any combination thereof to precipitate calcium carbonate (CaCO₃) and regenerating calcium hydroxide (Ca(OH)₂) and carbon dioxide (CO₂), wherein the regenerated calcium hydroxide is added to the reactor and for post-treatment of the permeate water and the carbon dioxide is used for post-treatment of the permeate water.

It is another object of the presently disclosed subject matter to provide the post-treatment method as defined above, wherein feeding at least a portion of intake sea water through the at least one reactor also precipitates magnesium hydroxide (Mg(OH)₂) for post-treatment of the permeate water.

It is another object of the presently disclosed subject matter to provide the post-treatment method as defined above, wherein desalinating said intake sea water comprises delivering the intake water to at least one pass comprising at least one reverse osmosis membrane to produce the permeate water and brine.

It is another object of the presently disclosed subject matter to provide the post-treatment method as defined above, further comprising the step of regenerating at least some of the calcium carbonate precipitant to a calcium-based chemical and carbon dioxide.

It is another object of the presently disclosed subject matter to provide the post-treatment method as defined above, wherein the calcium-based chemical is selected from a group consisting of calcium hydroxide or calcium oxide and any combination thereof.

It is another object of the presently disclosed subject matter to provide the post-treatment method as defined above, wherein regenerating the calcium carbonate to the calcium-based chemical comprises a method selected from at least one of calcinating the precipitated calcium carbonate, hydrolysing the precipitated calcium carbonate and any combination thereof.

It is another object of the presently disclosed subject matter to provide the post-treatment method as defined above, wherein the calcium-based chemical is calcium oxide and the process further comprises mixing at least a portion of the calcium oxide with at least a portion of intake sea water to form calcium hydroxide.

It is another object of the presently disclosed subject matter to provide the self-sustainable desalination process as defined above, wherein said step of regenerating at least some of the calcium carbonate precipitant comprises a method selected from at least one of calcinating the precipitated calcium carbonate, hydrolysing the precipitated calcium carbonate and any combination thereof.

It is another object of the presently disclosed subject matter to provide the self-sustainable desalination process as defined above, wherein said step of regenerating at least some of the calcium carbonate precipitant results in calcium-based chemical selected from a group consisting of calcium hydroxide or calcium oxide and any combination thereof.

It is another object of the presently disclosed subject matter to provide the self-sustainable desalination process as defined above, wherein said at least one regeneration module is selected from at least one of calcinator, hydrolysing module and any combination thereof.

It is another object of the presently disclosed subject matter to provide the self-sustainable desalination process as defined above, wherein said at least one regeneration module results in calcium-based chemical selected from a group consisting of calcium hydroxide or calcium oxide and any combination thereof.

According to a first aspect of the presently disclosed subject matter there is provided a process for the desalination of sea water, the process comprising:
feeding at least a portion of intake sea water through at least one reactor, for the removal of carbonates-based chemical; and
desalinating said intake sea water to produce permeate product water and brine.

Preferably, wherein the reactor containing calcium hydroxide (Ca(OH)₂) therein or is introduced with at least one selected from a group consisting calcium hydroxide (Ca(OH)₂), NaOH and any combination thereof to precipitate at least one carbonates-based chemical selected from a group consisting of calcium carbonate (CaCO₃).

Preferably, wherein the reactor containing calcium hydroxide (Ca(OH)₂) therein or is introduced with at least one selected from a group consisting calcium hydroxide (Ca(OH)₂), NaOH and any combination thereof to precipitate at least one carbonates-based chemical selected from a group consisting of calcium carbonate (CaCO₃), according to the following formula: Ca(OH)₂+Ca(HCO3)₂->2CaCO3+2H2O.

Preferably, the process includes the step of introducing calcium hydroxide (Ca(OH)₂) into the at least one reactor. Desalinating said intake sea water preferably comprises delivering the intake water to at least one pass comprising at least one reverse osmosis membrane to produce the permeate water and brine. Preferably, feeding at least a portion of intake sea water through at least one reactor containing calcium hydroxide (Ca(OH)₂) increases the pH of the intake water to at least pH 8.3. This enhances the boron rejection by the at least one reverse osmosis membrane to increase the overall efficiency of the process.

It is preferable for the process to include a step of regenerating chemicals from the calcium carbonate precipitant which may be re-used in the process, thereby enhancing the sustainability of the process. In a preferred embodiment, the process further comprises converting at least some of the calcium carbonate precipitant to a calcium-based chemical and carbon dioxide. The precipitated calcium carbonate may produce at least one selected from a group consisting of calcium hydroxide, calcium oxide, carbon dioxide and any combination thereof. Preferably, the calcium-based chemical is calcium hydroxide (Ca(OH)₂). More preferably, the process comprises adding at least a portion of the converted calcium-based chemical and carbon dioxide to the permeate to produce product water.

The conversion of the calcium carbonate to the calcium-based chemical may comprise a method selected from at least one of calcinating the precipitated calcium carbonate, hydrolysing the precipitated calcium carbonate and any combination thereof. If the calcium-based chemical is calcium oxide, the process may further comprise mixing at least a portion of the calcium oxide with at least a portion of intake sea water to form calcium hydroxide.

In one embodiment, the step of regenerating the calcium carbonate comprises calcination comprising heating the calcium carbonate to a temperature of at least 500° C.

In an alternative embodiment, the step of regenerating calcium carbonate comprises hydrolysing the calcium carbonate to produce at least one selected from the group consisting of calcium hydroxide, calcium oxide, carbon dioxide and any combination thereof. Preferably, said step of hydrolysis of the calcium carbonate is performed at a temperature of less than 500° C.

The sustainability of the process may be further enhanced by at least a portion of the calcium hydroxide formed by conversion of the calcium carbonate being recycled for use in the at least one reactor. Preferably, at least a portion of the calcium hydroxide formed by regeneration of the calcium carbonate is at least one selected from (a) recycled for use in the at least one reactor; (b) used in the post treatment process; (c) any combination thereof.

Optionally, feeding at least a portion of intake sea water through the at least one reactor containing calcium hydroxide (Ca(OH)₂) also precipitates magnesium hydroxide (Mg(OH)₂). The process may further comprise the step of regenerating at least some of the magnesium hydroxide precipitant to a magnesium-based chemical. At least a portion of the regenerated magnesium-based chemical may be added to the permeate to produce product water.

Alternatively, at least a portion of intake sea water through at least one second reactor adapted to precipitate magnesium-based chemical selected from a group consisting of magnesium hydroxide, magnesium oxide and any combination thereof.

Alternatively, at least a portion of the magnesium-based chemical (MgOH or MgO) is at least one selected from (a) recycled for use in the at least one reactor; (b) used in the post treatment process; (c) any combination thereof.

Thus, according to one embodiment of the first aspect of the presently disclosed subject matter, the process comprises feeding at least a portion of intake sea water through the at least one reactor containing calcium hydroxide (Ca(OH)₂) also precipitates magnesium hydroxide; and the process further comprises the steps of (i) regenerating at least some of the calcium carbonate and magnesium hydroxide precipitants to produce a calcium-based chemical, a magnesium-based chemical and carbon dioxide; and, (ii) mixing at least some of the regenerated chemicals and carbon dioxide with the permeate product water to produce drinking water.

Alternatively, at least a portion of intake sea water through at least one second reactor adapted to precipitate magnesium-based chemical selected from a group consisting of magnesium hydroxide, magnesium oxide and any combination thereof.

All of the sea water may pass through the at least one reactor or only a portion of the sea water may be fed through the reactor with the remaining intake sea water bypassing the at least one reactor. The process may further comprise a step of mixing said portion of the sea water fed through the at least one reactor with the remaining intake sea water bypassing the at least one reactor.

The process may include passing at least a portion of the sea water through at least one filter unit. Additionally, or alternatively, the intake sea water may be delivered to a clearwell.

In one embodiment of the process of the presently disclosed subject matter at least a portion of the permeate from the at least one reverse osmosis membrane of a first pass is delivered to a second pass of brackish water reverse osmosis. Preferably, at least one of sodium hydroxide or calcium hydroxide is added to the permeate prior to its introduction to the second pass. More preferably, calcium hydroxide regenerated from the conversion of precipitated calcium carbonate is added to the permeate prior to its introduction into the second pass.

The process according to the presently disclosed subject matter preferably excludes a calcium carbonate contactor in the post-treatment of the permeate water. The ability to provide a process having a post treatment method with no carbonate contactor reactors also provides a significant benefit. Carbonate contactors are relatively huge reactors, but the current process requires only smaller (Ca(OH)₂) reactors to deliver the final product. This is possible due to the reverse osmosis passes operating at higher pH to provide better biofouling resistance and better boron rejection, enabling the use of only (Ca(OH)₂) reactors without the need for CaCO₃ reactors.

According to a second aspect of the presently disclosed subject matter there is provided a desalination system having enhanced sustainability, the system comprising:
at least one conduit for delivering at least a portion of an intake sea water to the at least one reactor for the removal of carbonates-based chemical; and
at least one reverse osmosis pass comprising at least one reverse osmosis membrane, wherein at least a portion of the intake sea water is delivered through the at least one reactor prior to being delivered through the pass to produce permeate product water and brine.

Preferably, said at least one reactor having a calcium hydroxide (Ca(OH)₂) source to precipitate at least one carbonates-based chemical selected from a group consisting of calcium carbonate (CaCO₃).

Preferably, the reactor containing calcium hydroxide (Ca(OH)₂) therein or is introduced with at least one selected from a group consisting calcium hydroxide (Ca(OH)₂), NaOH and any combination thereof to precipitate at least one carbonates-based chemical selected from a group consisting of calcium carbonate (CaCO₃), according to the following formula: Ca(OH)₂+Ca(HCO3)₂->2CaCO3+2H2O.

Preferably, at least one regeneration module is provided to convert at least some of the calcium carbonate precipitant to a calcium-based chemical and carbon dioxide. The at least one regeneration module may be selected from at least one of a calcinatory, a hydrolysis reactor and any combination thereof. If a calcinatory is provided, the precipitated calcium carbonate may produce at least one of calcium hydroxide, calcium oxide, carbon dioxide and any combination thereof. The calcinatory may comprise a rotary kiln operating at a temperature of at least 500° C. Alternatively, the regeneration module may comprise at least one hydrolysis reactor for hydrolysing the calcium carbonate to produce at least one of calcium hydroxide (Ca(OH)₂), calcium oxide (CaO), carbon dioxide (CO₂) and any combination thereof. Preferably, said hydrolysis reactor operates at a temperature of less than 500° C.

It is preferable for at least a portion of the calcium hydroxide, Ca(OH)₂, to be recycled for use in the at least one at least one reactor.

In one embodiment, the calcinatory provided for calcinating the precipitated calcium carbonate may produce calcium oxide and the system further comprises at least one mixing reactor adapted to mix at least a portion of the calcium oxide with at least a portion of the intake sea water to produce calcium hydroxide (Ca(OH)₂).

Preferably, the system includes at least one pipe is provided to deliver at least one, preferably both, of a portion of the calcium-based chemical and carbon dioxide formed by the regeneration module to the permeate produced by the at least one reverse osmosis membrane to produce the product water. Alternatively or, more preferably, additionally, the system includes at least one pipe is provided to recycle at least a portion of the calcium-based chemical formed by the regeneration module to the at least one reactor.

The at least one reactor may also precipitate magnesium hydroxide from the intake sea water and at least one regeneration module is configured to regenerate at least some of the magnesium hydroxide precipitant to a magnesium-based chemical. The system may further comprise at least one pipe to deliver at least a portion of the magnesium-based chemical formed by the regeneration module to the permeate produced by the at least one reverse osmosis membrane to produce drinking water. Alternatively, at least a portion of intake sea water through at least one second reactor adapted to precipitate magnesium-based chemical selected from a group consisting of magnesium hydroxide, magnesium oxide and any combination thereof.

In one embodiment, a bypass may be provided between the intake sea water and the reverse osmosis pass to enable the delivery of a proportion of the sea water through the at least one reactor with the remaining intake sea water bypassing the at least one reactor.

At least one, preferably both, of a filter unit and a clearwell is provided between the at least one reactor and the pass.

Preferably, the at least one reactor is a fluidized bed reactor.

The system may further comprise a second brackish water reverse osmosis pass (BWRO) is in fluid communication with the first pass, wherein at least a portion of the permeate from the first pass is delivered to the second pass. Preferably, at least one of a sodium hydroxide and/or calcium hydroxide source is provided between the first and second pass to introduce sodium hydroxide or calcium hydroxide to the permeate prior to its introduction to the second pass. Preferably, a double pass is employed to improve rejection of boron. Less sodium hydroxide or calcium hydroxide may be used than in a conventional two pass SWRO/BWRO process due to the higher pH of the SWRO permeate and better boron rejection at high pH in the SWRO. Post treatment reactors may again be replaced with the simple addition of calcium hydroxide and carbon dioxide to form the final product as with the single pass process and system, without the need for calcium carbonate contactors.

Preferably, at least a portion of the intake sea water delivered through the at least one reactor results in an increase in pH of the at least a portion of the intake water to a pH of at least 8.3, thereby enhancing boron rejection by said at least one reverse osmosis membrane to increase the overall efficiency of the desalination system.

A third aspect of the presently disclosed subject matter provides a self-sustainable desalination process for the desalination of sea water, the process comprising:
delivering sea water to an intake pipe;
introducing calcium hydroxide (Ca(OH)₂) into at least one reactor;
passing at least a portion of the intake sea water through the reactor to precipitate at least calcium carbonate (CaCO₃) from the sea water;
delivering under pressure all the intake water to at least one pass comprising at least one reverse osmosis membrane to produce permeate and brine;
regenerating at least some of the calcium carbonate (CaCO₃) precipitant to at least one selected from the group consisting of calcium hydroxide (Ca(OH)₂), calcium oxide (CaO) and carbon dioxide (CO₂) and any combination thereof; and
adding at least a portion of at least one of the calcium hydroxide (Ca(OH)₂), calcium oxide (CaO) and carbon dioxide (CO₂) and any combination thereof regenerated from the calcium carbonate (CaCO₃) precipitant to at least one of (i) the permeate to produce product water and (ii) the at least one reactor, and any combination thereof.

According to one embodiment of the presently disclosed subject matter, the step of regenerating at least some of the calcium carbonate precipitant preferably comprises a method selected from at least one of calcinating the precipitated calcium carbonate, hydrolysing the precipitated calcium carbonate and any combination thereof. Preferably, said step of regenerating at least some of the calcium carbonate precipitant results in calcium-based chemical selected from a group consisting of calcium hydroxide or calcium oxide and any combination thereof.

According to a fourth aspect of the presently disclosed subject matter there is provided a self-sustainable desalination system for the desalination of sea water, the system comprising:
a sea water intake;
at least one reactor having a calcium hydroxide (Ca(OH)₂) source;
at least one conduit for delivering at least a portion of the sea water from the intake to the at least one reactor to precipitate calcium carbonate (CaCO₃);
at least one reverse osmosis pass comprising at least one reverse osmosis membrane, wherein all the intake sea water is delivered through the pass to produce permeate and brine;
at least one regeneration module to convert at least some of the calcium carbonate (CaCO₃) precipitant to at least one selected from a group consisting of calcium hydroxide (Ca(OH)₂), calcium oxide (CaO), carbon dioxide (CO₂) and any combination thereof; and
a recycling system to deliver at least a portion of at least one of the calcium hydroxide (Ca(OH)₂), calcium oxide (CaO) and carbon dioxide (CO₂) and any combination thereof regenerated from the calcium carbonate (CaCO₃) precipitant to at least one of (i) the permeate to produce product water and (ii) the at least one reactor and any combination thereof.

Preferably, the at least one regeneration module is selected from at least one of calcinator, hydrolysing module and any combination thereof. The at least one regeneration module preferably results in calcium-based chemical selected from a group consisting of calcium hydroxide or calcium oxide and any combination thereof.

A fifth aspect of the presently disclosed subject matter provides a calcium carbonate reactor-free post-treatment desalination method for the treatment of permeate water comprising step of adding at least one of calcium hydroxide (Ca(OH)₂) and magnesium hydroxide (Mg(OH)₂) to intake sea water prior to desalinating the same, wherein said post-treatment desalination method is free of calcium carbonate reactor.

Preferably, at least one of the calcium hydroxide (Ca(OH)₂) and magnesium hydroxide (Mg(OH)₂) is regenerated from the carbonate precipitated during said step of adding at least one of calcium hydroxide (Ca(OH)₂) and magnesium hydroxide (Mg(OH)₂) to intake sea water.

The post-treatment method may further comprise feeding at least a portion of intake sea water through at least one reactor, the reactor containing calcium hydroxide (Ca(OH)₂) therein or is introduced with at least one selected from a group consisting calcium hydroxide (Ca(OH)₂), NaOH and any combination thereof to precipitate at least one carbonates-based chemical selected from a group consisting of calcium carbonate (CaCO₃) and regenerating calcium hydroxide (Ca(OH)₂) and carbon dioxide (CO₂), wherein the regenerated calcium hydroxide is added to the reactor and for post-treatment of the permeate water and the carbon dioxide is used for post-treatment of the permeate water.

Feeding at least a portion of intake sea water through the at least one reactor may also precipitate magnesium hydroxide (Mg(OH)₂) for post-treatment of the permeate water. Alternatively, at least a portion of intake sea water through at least one second reactor adapted to precipitate magnesium-based chemical selected from a group consisting of magnesium hydroxide, magnesium oxide and any combination thereof.

The post-treatment method may include desalinating said intake sea water comprising delivering the intake water to at least one pass comprising at least one reverse osmosis membrane to produce the permeate water and brine. Preferably, the post-treatment method further comprises the step of regenerating at least some of the calcium carbonate precipitant to a calcium-based chemical and carbon dioxide, wherein the calcium-based chemical is selected from a group consisting of calcium hydroxide or calcium oxide and any combination thereof. Preferably, regenerating the calcium carbonate to the calcium-based chemical comprises a method selected from at least one of calcinating the precipitated calcium carbonate, hydrolysing the precipitated calcium carbonate and any combination thereof. In a post-treatment method wherein the calcium-based chemical is calcium oxide, the process may further comprise mixing at least a portion of the calcium oxide with at least a portion of intake sea water to form calcium hydroxide.

According to a sixth aspect of the presently disclosed subject matter there is provided a self-sustainable desalination process for the desalination of sea water, the process comprising:
delivering sea water to an intake pipe;
introducing magnesium hydroxide (Mg(OH)₂) into at least one reactor;
passing at least a portion of the intake sea water through the reactor to precipitate at least magnesium carbonate (MgCO₃) from the sea water;
delivering under pressure all the intake water to at least one pass comprising at least one reverse osmosis membrane to produce permeate and brine;
regenerating at least some of the magnesium carbonate (MgCO₃) precipitant to at least one of magnesium hydroxide (Mg(OH)₂), magnesium oxide (MgO) and carbon dioxide (CO₂) and any combination thereof; and
adding at least a portion of at least one of the magnesium hydroxide (Mg(OH)₂), magnesium oxide (MgO) and carbon dioxide (CO₂) and any combination thereof regenerated from the magnesium carbonate (MgCO₃) precipitant to at least one of (i) the permeate to produce product water and (ii) the at least one reactor, and any combination thereof.

A seventh aspect of the presently disclosed subject matter provides a self-sustainable desalination system for the desalination of sea water, the system comprising:
a sea water intake;
at least one reactor having a magnesium hydroxide (Mg(OH)₂) source;
at least one conduit for delivering at least a portion of the sea water from the intake to the at least one reactor to precipitate magnesium carbonate (MgCO₃);
at least one reverse osmosis pass comprising at least one reverse osmosis membrane, wherein all the intake sea water is delivered through the pass to produce permeate and brine;
at least one regeneration module to convert at least some of the magnesium carbonate (MgCO₃) precipitant to at least one selected from a group consisting of magnesium hydroxide (Mg(OH)₂), magnesium oxide (MgO), carbon dioxide (CO₂) and any combination thereof; and
a recycling system to deliver at least a portion of at least one of the magnesium hydroxide (Mg(OH)₂), magnesium oxide (MgO) and carbon dioxide (CO₂) and any combination thereof regenerated from the magnesium carbonate (MgCO₃) precipitant to at least one of (i) the permeate to produce product water and (ii) the at least one reactor and any combination thereof.

In the case where magnesium oxide (MgO) is regenerated from the precipitant, the oxide is preferably mixed with water to produce magnesium hydroxide (Mg(OH)₂) for recycling.

The product water produced by the various aspects of the presently disclosed subject matter preferably comprises drinking water.

Any excess of the produced chemicals, such as calcium-based, magnesium-based and carbon dioxide may be sold as an additional income.

It is to be appreciated that different types of regeneration methods and systems may be used for the production of calcium hydroxide, calcium oxide and carbon dioxide from the precipitated calcium carbonate and/or for regeneration of magnesium-based chemicals from magnesium hydroxide, as are known in the art.

### BRIEF DESCRIPTION OF THE DRAWINGS

For a better understanding of the presently disclosed subject matter and to show more clearly how it may be carried into effect, reference will now be made by way of example only to the accompanying drawings in which:

FIG. 1 is a schematic diagram illustrating a single pass SWRO system according to the prior art; and

FIG. 2 is a schematic diagram illustrating a double pass SWRO and BWRO system according to the prior art;

FIG. 3 is a schematic diagram of a more sustainable single pass SWRO system according to one embodiment of the presently disclosed subject matter;

FIG. 4 is a schematic diagram of a more sustainable double pass SWRO and BWRO system according to another embodiment of the presently disclosed subject matter;

FIG. 5 illustrates the hydrolysis of calcium carbonate;

FIG. 6 is a schematic diagram of a more sustainable single pass SWRO system according to another embodiment of the presently disclosed subject matter; and

FIG. 7 is a schematic diagram of a more sustainable double pass SWRO and BWRO system according to another embodiment of the presently disclosed subject matter.

FIG. 8 is a schematic diagram of an embodiment substantially similar to FIG. 7 only with a difference that at least a portion of the calcium carbonate being used in the post treatment process (as an alternative to regenerating the same in the reactor).

FIG. 9 is a schematic diagram of an embodiment substantially similar to FIG. 3 only with a difference that at least a portion of the calcium carbonate being used in the post treatment process (as an alternative to regenerating the same in the reactor).

FIG. 10 is a schematic diagram of an embodiment substantially similar to FIG. 4 only with a difference that at least a portion of the calcium carbonate being used in the post treatment process (as an alternative to regenerating the same in the reactor).

FIG. 11 is a schematic diagram of an embodiment substantially similar to FIG. 6 only with a difference that at least a portion of the calcium carbonate being used in the post treatment process (as an alternative to regenerating the same in the reactor).

FIGS. 12-12a illustrating an embodiment essentially equivalent to the embodiment of FIG. 3 (or 9) in which the precipitation reactor 2 containing or is introduced with NaOH to precipitate Calcium-based chemicals,

FIGS. 13-13a illustrating an embodiment essentially equivalent to the embodiment of FIG. 4 (or 10) in which the precipitation reactor 2 containing or is introduced with NaOH to precipitate Calcium-based chemicals

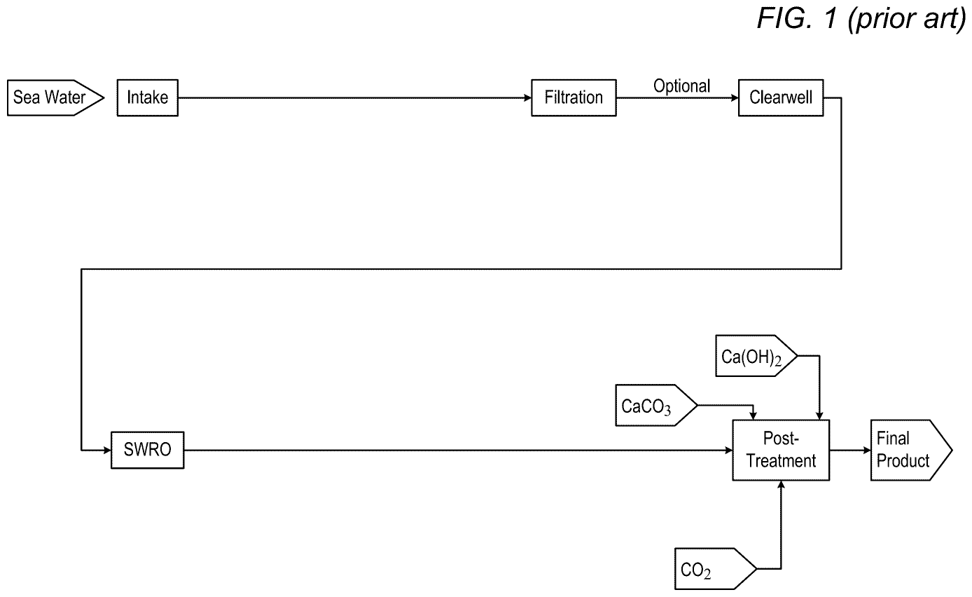

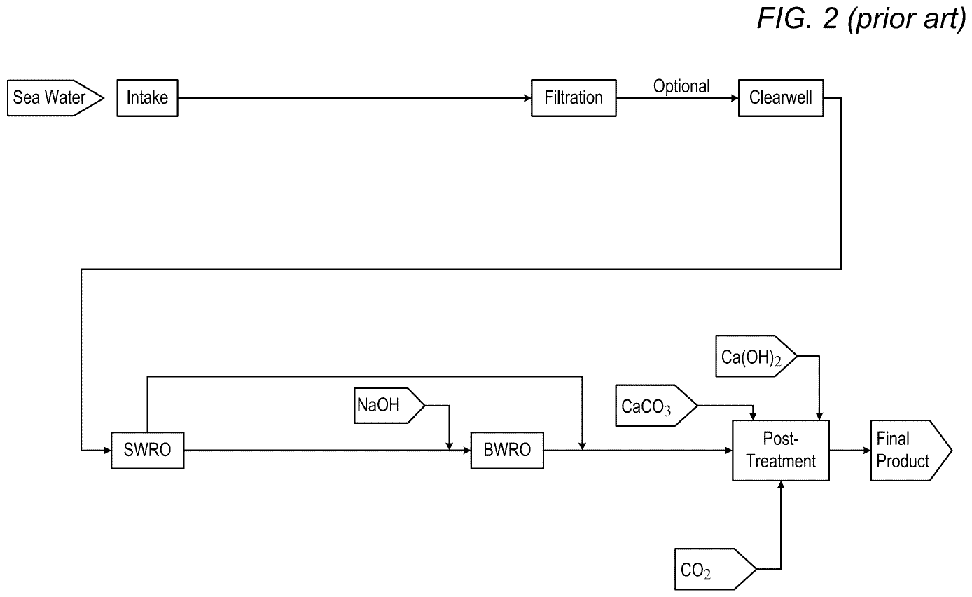

### DETAILED DESCRIPTION

The presently disclosed subject matter is concerned with improving a sea water desalination process and plant by increasing their sustainability. This is achieved by the self-generation of most of the chemicals used in the desalination process/plant, thus reducing the need to deliver chemicals to the plant. In addition, the process also improves the boron rejection by the SWRO and reduces the overall footprint of the desalination plant. This provides an overall cost reduction in the production of desalinated water as well as providing a more sustainable process.

It is one object of the presently disclosed subject matter to provide a process for the desalination of sea water, the process comprising:
feeding at least a portion of intake sea water through at least one reactor for the removal of carbonates-based chemical; and
desalinating said intake sea water to produce permeate product water and brine.

It is another object of the presently disclosed subject matter to provide the process as defined above, wherein the reactor containing calcium hydroxide (Ca(OH)₂) therein or is introduced with at least one selected from a group consisting calcium hydroxide (Ca(OH)₂), NaOH and any combination thereof to precipitate at least one carbonates-based chemical selected from a group consisting of calcium carbonate (CaCO₃).

It is another object of the presently disclosed subject matter to provide the process as defined above, wherein the reactor containing calcium hydroxide (Ca(OH)₂) therein or is introduced with at least one selected from a group consisting calcium hydroxide (Ca(OH)₂), NaOH and any combination thereof to precipitate at least one carbonates-based chemical selected from a group consisting of calcium carbonate (CaCO₃), according to the following formula: Ca(OH)₂+Ca(HCO3)₂->2CaCO3+2H2O.

It is another object of the presently disclosed subject matter to provide the process as defined above, further comprising introducing calcium hydroxide (Ca(OH)₂) into the at least one reactor.

It is another object of the presently disclosed subject matter to provide the process as defined above, wherein feeding at least a portion of intake sea water through at least one reactor containing calcium hydroxide (Ca(OH)₂) increases the pH of the intake water to at least pH 8.3.

It is another object of the presently disclosed subject matter to provide the process as defined above, wherein desalinating said intake sea water comprises delivering the intake water to at least one pass comprising at least one reverse osmosis membrane to produce the permeate water and brine.

It is another object of the presently disclosed subject matter to provide the process as defined above, further comprising the step of regenerating at least some of the calcium carbonate precipitant to a calcium-based chemical and carbon dioxide.

It is another object of the presently disclosed subject matter to provide the process as defined above, wherein the calcium-based chemical is selected from a group consisting of calcium hydroxide or calcium oxide and any combination thereof.

It is another object of the presently disclosed subject matter to provide the process as defined above, wherein regenerating the calcium carbonate to the calcium-based chemical comprises a method selected from at least one of calcinating the precipitated calcium carbonate, hydrolysing the precipitated calcium carbonate and any combination thereof.

It is another object of the presently disclosed subject matter to provide the process as defined above, wherein regenerating the calcium carbonate comprises calcination comprising heating the calcium carbonate to a temperature of at least 500° C.

It is another object of the presently disclosed subject matter to provide the process as defined above, wherein regenerating the calcium carbonate comprises hydrolysing the calcium carbonate to produce at least one selected from the group consisting of calcium hydroxide, calcium oxide, carbon dioxide and any combination thereof.

It is another object of the presently disclosed subject matter to provide the process as defined above, wherein said step of hydrolysis of the calcium carbonate is performed at a temperature of less than 500° C.

It is another object of the presently disclosed subject matter to provide the process as defined above, wherein the calcium-based chemical is calcium oxide and the process further comprises mixing at least a portion of the calcium oxide with at least a portion of intake sea water to form calcium hydroxide.

It is another object of the presently disclosed subject matter to provide the process as defined above, wherein at least a portion of the calcium hydroxide formed by regeneration of the calcium carbonate is at least one selected from (a) recycled for use in the at least one reactor; (b) used in the post treatment process; (c) any combination thereof.

It is another object of the presently disclosed subject matter to provide the process as defined above, wherein feeding at least a portion of intake sea water through the at least one reactor containing calcium hydroxide (Ca(OH)₂) also precipitates magnesium hydroxide.

Alternatively, at least a portion of intake sea water through at least one second reactor adapted to precipitate magnesium-based chemical selected from a group consisting of magnesium hydroxide, magnesium oxide and any combination thereof.

Alternatively, at least a portion of the magnesium-based chemical (MgOH or MgO) is at least one selected from (a) recycled for use in the at least one reactor; (b) used in the post treatment process; (c) any combination thereof.

It is another object of the presently disclosed subject matter to provide the process as defined above, further comprising the step of regenerating at least some of the magnesium hydroxide precipitant to a magnesium-based chemical.

It is another object of the presently disclosed subject matter to provide the process as defined above, further comprising adding at least a portion of the regenerated magnesium-based chemical to the permeate to produce product water.

It is another object of the presently disclosed subject matter to provide the process as defined above, wherein feeding at least a portion of intake sea water through the at least one reactor containing calcium hydroxide (Ca(OH)₂) also precipitates magnesium hydroxide; and the process further comprises the steps of (i) regenerating at least some of the calcium carbonate and magnesium hydroxide precipitants to produce a calcium-based chemical, a magnesium-based chemical and carbon dioxide; and, (ii) mixing at least some of the regenerated chemicals and carbon dioxide with the permeate product water to produce drinking water.

It is another object of the presently disclosed subject matter to provide the process as defined above, wherein only a portion of the sea water is fed through the reactor with the remaining intake sea water bypassing the at least one reactor.

It is another object of the presently disclosed subject matter to provide the process as defined above, further comprising step of mixing said portion of the sea water fed through the at least one reactor with the remaining intake sea water bypassing the at least one reactor.

It is another object of the presently disclosed subject matter to provide the process as defined above, further comprising delivering at least a portion of the sea water to at least one of a filter unit and a clearwell.

It is another object of the presently disclosed subject matter to provide the process as defined above, further comprising passing at least a portion of the permeate from the reverse osmosis membranes of a first pass to a second pass of brackish water reverse osmosis.

It is another object of the presently disclosed subject matter to provide the process as defined above, further comprising adding at least one of sodium hydroxide or calcium hydroxide to the permeate prior to its introduction to the second pass.

It is another object of the presently disclosed subject matter to provide the process as defined above, further comprising regenerating the calcium hydroxide from the calcium carbonate precipitant and adding at least a portion of the regenerated calcium hydroxide to the permeate prior to its introduction to the second pass.

It is another object of the presently disclosed subject matter to provide the process as defined above, wherein the process excludes calcium carbonate contactor in the post-treatment of the permeate water.

It is another object of the presently disclosed subject matter to provide a desalination system comprising:
at least one conduit for delivering at least a portion of an intake sea water to the at least one reactor for the removal of carbonates-based chemical; and
at least one reverse osmosis pass comprising at least one reverse osmosis membrane, wherein at least a portion of the intake sea water is delivered through the at least one reactor prior to being delivered through the pass to produce permeate product water and brine.

It is another object of the presently disclosed subject matter to provide the desalination system as defined above, wherein said at least one reactor having a calcium hydroxide (Ca(OH)₂) source to precipitate at least one carbonates-based chemical selected from a group consisting of calcium carbonate (CaCO₃).

It is another object of the presently disclosed subject matter to provide the desalination system as defined above, wherein the reactor containing calcium hydroxide (Ca(OH)₂) therein to precipitate at least one carbonates-based chemical selected from a group consisting of calcium carbonate (CaCO₃), according to the following formula: Ca(OH)₂+Ca(HCO3)₂->2CaCO3+2H2O.

It is another object of the presently disclosed subject matter to provide the desalination system as defined above, wherein at least one regeneration module is provided to convert at least some of the calcium carbonate precipitant to a calcium-based chemical and carbon dioxide.

It is another object of the presently disclosed subject matter to provide the desalination system as defined above, wherein said at least one regeneration module is selected from at least one of a calcinatory, a hydrolysis reactor and any combination thereof.

It is another object of the presently disclosed subject matter to provide the desalination system as defined above, wherein said at least one regeneration module is a calcinatory provided for calcinating the precipitated calcium carbonate to produce at least one of calcium hydroxide, calcium oxide, carbon dioxide and any combination thereof.

It is another object of the presently disclosed subject matter to provide the desalination system as defined above, wherein the calcinatory comprises a rotary kiln for calcination of the calcium carbonate.

It is another object of the presently disclosed subject matter to provide the desalination system as defined above, wherein the at least one regeneration module comprises at least one hydrolysis reactor for hydrolysing the calcium carbonate to produce at least one selected from a group consisting of calcium hydroxide (Ca(OH)₂), calcium oxide (CaO), carbon dioxide (CO₂) and any combination thereof.

It is another object of the presently disclosed subject matter to provide the desalination system as defined above, wherein said hydrolysis reactor operates at a temperature of less 500° C.

It is another object of the presently disclosed subject matter to provide the desalination system as defined above, wherein the calcinatory provided for calcinating the precipitated calcium carbonate produces calcium oxide and the system further comprises at least one mixing reactor adapted to mix at least a portion of the calcium oxide with at least a portion of the intake sea water to produce calcium hydroxide (Ca(OH)₂).

It is another object of the presently disclosed subject matter to provide the desalination system as defined above, wherein at least one pipe is provided to deliver at least one, preferably both, of a portion of the calcium-based chemical and carbon dioxide formed by the regeneration module to the permeate produced by the at least one reverse osmosis membrane to produce the product water.

It is another object of the presently disclosed subject matter to provide the desalination system as defined above, wherein at least one pipe is provided to recycle at least a portion of the calcium-based chemical formed by the regeneration module to the at least one reactor.

It is another object of the presently disclosed subject matter to provide the desalination system as defined above, wherein the at least one reactor also precipitates magnesium hydroxide from the intake sea water and at least one regeneration module is configured to regenerate at least some of the magnesium hydroxide precipitant to a magnesium-based chemical.

It is another object of the presently disclosed subject matter to provide the desalination system as defined above, further comprising at least one pipe to deliver at least a portion of the magnesium-based chemical formed by the regeneration module to the permeate produced by the at least one reverse osmosis membrane to produce drinking water.

It is another object of the presently disclosed subject matter to provide the desalination system as defined above, wherein the at least one reactor having a calcium hydroxide (Ca(OH)₂) source also precipitates magnesium hydroxide; and, the system includes at least one regeneration module regenerating at least some of the calcium carbonate and magnesium hydroxide precipitants to produce a calcium-based chemical, a magnesium-based chemical and carbon dioxide and piping to deliver at least some of the regenerated chemicals and carbon dioxide to the permeate product water to produce drinking water.

It is another object of the presently disclosed subject matter to provide the desalination system as defined above, wherein a bypass is provided between the intake sea water and the reverse osmosis pass to enable the delivery of a portion of the sea water through the at least one reactor with the remaining intake sea water bypassing the at least one reactor.

It is another object of the presently disclosed subject matter to provide the desalination system as defined above, wherein at least one of a filter unit and a clearwell is provided between the at least one reactor and the pass.

It is another object of the presently disclosed subject matter to provide the desalination system as defined above, wherein the at least one reactor is a fluidized bed reactor.

It is another object of the presently disclosed subject matter to provide the desalination system as defined above, wherein a second brackish water reverse osmosis pass is in fluid communication with the first pass, wherein at least a portion of the permeate from the first pass is delivered to the second pass.

It is another object of the presently disclosed subject matter to provide the desalination system as defined above, wherein at least one of a sodium hydroxide and calcium hydroxide source and any combination is provided between the first and second pass to introduce sodium hydroxide or calcium hydroxide to the permeate prior to its introduction to the second pass.

It is another object of the presently disclosed subject matter to provide the desalination system as defined above, wherein at least a portion of the intake sea water delivered through the at least one reactor results in an increase in pH of the at least a portion of the intake water to a pH of at least 8.3.

It is another object of the presently disclosed subject matter to provide the desalination system as defined above, wherein said increase in pH to at least 8.3 of at least a portion of the intake sea water enhances boron rejection by said at least one reverse osmosis membrane to thereby increase the overall efficiency of the desalination system.

It is another object of the presently disclosed subject matter to provide a self-sustainable desalination process for the desalination of sea water, the process comprising:
delivering sea water to an intake pipe;
carbonates-based chemical removing from said sea water;
delivering under pressure all the intake water to at least one pass comprising at least one reverse osmosis membrane to produce permeate and brine.

It is another object of the presently disclosed subject matter to provide the self-sustainable desalination process as defined above, wherein said carbonates-based chemical removing is performed by introducing calcium hydroxide (Ca(OH)₂) into at least one reactor; and passing at least a portion of the intake sea water through the reactor to precipitate at least calcium carbonate (CaCO₃) from the sea water.

It is another object of the presently disclosed subject matter to provide the self-sustainable desalination process as defined above, additionally comprising step of regenerating at least one selected from the group consisting of calcium hydroxide (Ca(OH)₂), calcium oxide (CaO), carbon dioxide (CO₂), magnesium hydroxide (Mg(OH)₂) and any combination thereof.

It is another object of the presently disclosed subject matter to provide the self-sustainable desalination process as defined above, wherein said step of regenerating at least one selected from the group consisting of calcium hydroxide (Ca(OH)₂), calcium oxide (CaO), carbon dioxide (CO₂), magnesium hydroxide (Mg(OH)₂) and any combination thereof from said carbonates-based chemical.

It is another object of the presently disclosed subject matter to provide the self-sustainable desalination process as defined above, additionally comprising step of adding at least a portion of at least one of the calcium hydroxide (Ca(OH)₂), calcium oxide (CaO) and carbon dioxide (CO₂) and any combination thereof regenerated from the calcium carbonate (CaCO₃) precipitant to at least one of (i) the permeate to produce product water and (ii) the at least one reactor, and any combination thereof.

It is another object of the presently disclosed subject matter to provide a self-sustainable desalination system for the desalination of sea water, the system comprising:
a sea water intake;
at least one reactor having a calcium hydroxide (Ca(OH)₂) source;
at least one conduit for delivering at least a portion of the sea water from the intake to the at least one reactor to precipitate calcium carbonate (CaCO₃);
at least one reverse osmosis pass comprising at least one reverse osmosis membrane, wherein all the intake sea water is delivered through the pass to produce permeate and brine;
at least one regeneration module to convert at least some of the calcium carbonate (CaCO₃) precipitant to at least one selected from a group consisting of calcium hydroxide (Ca(OH)₂), calcium oxide (CaO), carbon dioxide (CO₂) and any combination thereof; and
a recycling system to deliver at least a portion of at least one of the calcium hydroxide (Ca(OH)₂), calcium oxide (CaO) and carbon dioxide (CO₂) and any combination thereof regenerated from the calcium carbonate (CaCO₃) precipitant to at least one of (i) the permeate to produce product water and (ii) the at least one reactor and any combination thereof.

It is another object of the presently disclosed subject matter to provide a calcium carbonate reactor-free post-treatment desalination method for the treatment of permeate water comprising step of adding at least one of calcium hydroxide (Ca(OH)₂), magnesium hydroxide (Mg(OH)₂) to intake sea water prior to desalinating the same, wherein said post-treatment desalination method is free of calcium carbonate reactor.

It is another object of the presently disclosed subject matter to provide the post-treatment method as defined above, wherein at least one of the calcium hydroxide (Ca(OH)₂), magnesium hydroxide (Mg(OH)₂) is regenerated calcium carbonate precipitated during said step of adding at least one of calcium hydroxide (Ca(OH)₂), magnesium hydroxide (Mg(OH)₂) to intake sea water.

It is another object of the presently disclosed subject matter to provide the post-treatment method as defined above, further comprising feeding at least a portion of intake sea water through at least one reactor, the reactor containing calcium hydroxide (Ca(OH)₂) therein or is introduced with at least one selected from a group consisting calcium hydroxide (Ca(OH)₂), NaOH and any combination thereof to precipitate at least one carbonates-based chemical selected from a group consisting of calcium carbonate (CaCO₃) and regenerating calcium hydroxide (Ca(OH)₂) and carbon dioxide (CO₂), wherein the regenerated calcium hydroxide is added to the reactor and for post-treatment of the permeate water and the carbon dioxide is used for post-treatment of the permeate water.

It is another object of the presently disclosed subject matter to provide the post-treatment method as defined above, wherein feeding at least a portion of intake sea water through the at least one reactor also precipitates magnesium hydroxide (Mg(OH)₂) for post-treatment of the permeate water.

It is another object of the presently disclosed subject matter to provide the post-treatment method as defined above, wherein desalinating said intake sea water comprises delivering the intake water to at least one pass comprising at least one reverse osmosis membrane to produce the permeate water and brine.

It is another object of the presently disclosed subject matter to provide the post-treatment method as defined above, further comprising the step of regenerating at least some of the calcium carbonate precipitant to a calcium-based chemical and carbon dioxide.

It is another object of the presently disclosed subject matter to provide the post-treatment method as defined above, wherein the calcium-based chemical is selected from a group consisting of calcium hydroxide or calcium oxide and any combination thereof.

It is another object of the presently disclosed subject matter to provide the post-treatment method as defined above, wherein regenerating the calcium carbonate to the calcium-based chemical comprises a method selected from at least one of calcinating the precipitated calcium carbonate, hydrolysing the precipitated calcium carbonate and any combination thereof.

It is another object of the presently disclosed subject matter to provide the post-treatment method as defined above, wherein the calcium-based chemical is calcium oxide and the process further comprises mixing at least a portion of the calcium oxide with at least a portion of intake sea water to form calcium hydroxide.

It is another object of the presently disclosed subject matter to provide the self-sustainable desalination process as defined above, wherein said step of regenerating at least some of the calcium carbonate precipitant comprises a method selected from at least one of calcinating the precipitated calcium carbonate, hydrolysing the precipitated calcium carbonate and any combination thereof.

It is another object of the presently disclosed subjected matter to provide the self-sustainable desalination process as defined above, wherein said step of regenerating at least some of the calcium carbonate precipitant results in calcium-based chemical selected from a group consisting of calcium hydroxide or calcium oxide and any combination thereof.

It is another object of the presently disclosed subject matter to provide the self-sustainable desalination process as defined above, wherein said at least one regeneration module is selected from at least one of calcinator, hydrolysing module and any combination thereof.

It is another object of the presently disclosed subject matter to provide the self-sustainable desalination process as defined above, wherein said at least one regeneration module results in calcium-based chemical selected from a group consisting of calcium hydroxide or calcium oxide and any combination thereof.

According to one embodiment of the presently disclosed subject matter input sea water are reacted with lime (calcium hydroxide, Ca(OH)₂) prior to its passage through the reverse osmosis passes to precipitate calcium carbonate. The calcium carbonate is then subsequently regenerated (by e.g., calcination/hydrolysis, as will be detailed hereinbelow, of the calcium carbonate) for reuse in the process/plant. This provides for a series of benefits in the overall cost efficiency and sustainability of the process/plant as detailed below.

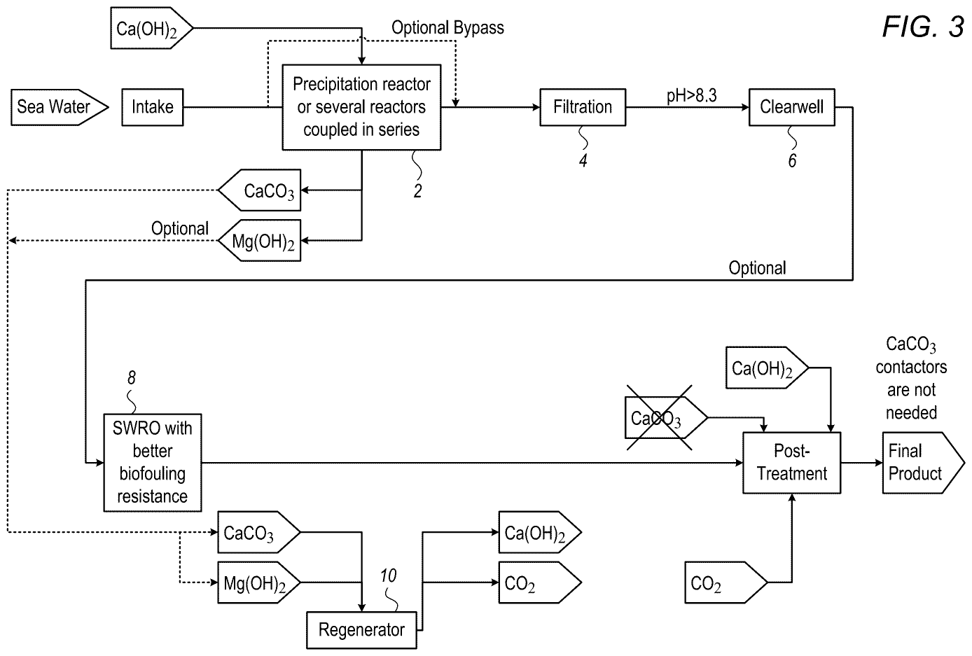

FIG. 3 of the accompanying drawings is a schematic diagram of a modified single pass SWRO system according to one embodiment of the presently disclosed subject matter. The most significant change is the addition of at least one precipitation reactor 2 (such as a fluidized bed reactor) through which at least a portion of the initial sea water is passed prior to filtration 4 for carbonate removal. In the illustrated embodiment, the filtered water is then delivered to a clearwell 6 although it is to be appreciated that the use of a clearwell is optional. Calcium hydroxide is introduced into the at least one pellet reactor 2 raising the pH of the water to at least 8.3 or higher for carbon removal by precipitating out calcium carbonate (and, optionally, magnesium hydroxide), according to the following equation:

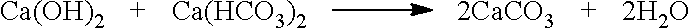

This leads to the SWRO 8 operating at a higher pH which provides better biofouling resistance, better boron rejection and enables post treatment reactors to be free from calcium carbonate reactors. Instead, the post treatment reactors are replaced with the simple addition of lime (calcium hydroxide) and carbon dioxide to form the final product.

Thus, it is within the scope of the presently disclosed subject matter to provide a desalination process and plant where calcium carbonate contactors are not required. Additionally, the calcium carbonate pellets produced as a by-product from the at least one precipitation reactor 2 are delivered to a regenerator 10 for the production of calcium-based chemicals, such as calcium hydroxide, calcium oxide, and carbon dioxide. The calcium-based chemicals will be reused in the at least one pellet reactor 2 (or in the post treatment process) and the carbon dioxide would be used in the post treatment process (to produce drinking water). It should be noted that it could be a pellet reactor or a series of pellet reactors. Each of the pellet reactor could produce one or a combination of calcium-based chemicals, such as calcium hydroxide, calcium oxide, and carbon dioxide; and/or magnesium based chemicals selected from a group consisting of magnesium hydroxide, magnesium oxide and any combination thereof.

According to one embodiment the regeneration of calcium carbonate back to calcium hydroxide is provided by means of a calcinatory (kiln, burner), hydrolysis or any other methods known in the art.

In case the regenerator 10 is a calcinator, the calcium carbonate is calcinated to result in the production of quicklime (calcium oxide) and carbon dioxide. The exothermic mixing reaction of quicklime (calcium oxide) with water will result in lime (calcium hydroxide)—which could be, as detailed above, reused and introduced back to the pellet reactor 2. The energy released by this exothermic reaction can be used to compensate some of the thermal energy used for the calcination process. Alternatively, the calcium hydroxide may be used in the post treatment process. Additionally or alternatively, some of the calcium carbonate may be used in the post treatment process (as an alternative to regenerating the same in the reactor).

Additionally or alternatively, some of the magnesium-based is used in the post treatments of the permeate water post the desalination step.

It should be noted that it is within the scope of the presently disclosed subject matter to provide a calcination process in which the calcium carbonate is calcinated to form lime (calcium hydroxide) and carbon dioxide.

As noted above, at least a portion of the lime and carbon dioxide is recycled within the system for use within the pellet reactor (re-use of lime) or for post treatment of the permeate. Additionally, excess lime and carbon dioxide can be sold as an additional income. Alternatively, at least a portion of the calcium carbonate can be used for post treatment of the permeate.

It is to be appreciated that some or all of the intake water may pass through the precipitation reactor 2 to increase the pH of the water and form calcium carbonate. According to one embodiment, only a portion is passed through the reactor. According to that embodiment, a bypass channel should be provided, as indicated by the dashed lines in FIG. 3. Furthermore, according to that embodiment, both portions of the intake water join together before the filtration unit 4.

As mentioned above, one of the advantages of the presently disclosed subject matter is its operation at a higher pH that improves the boron rejection. In this respect, boron is naturally found in seawater and can adversely affect both humans and agriculture. Poor rejection of boron by RO membranes due to its small size and the boric molecule's lack of charge at neutral and low pH represents a significant challenge. Elevating the pH of the feed water increases the rejection of boron by the RO membranes; and, increases the overall efficiency of the process.

Another significant advantage provided by the modified process of the presently disclosed subject matter is the self-sustainability provided by the on-situ production of calcium-based chemicals and carbon dioxide from the calcium carbonate precipitated which can be used for the post-treatment of the permeate to form product water, as well as being fed back to the pellet reactor. The process enables a much lower chemical consumption overall and allows for the use of smaller reactors.

Furthermore, the process is also environmentally friendly because it reduces the amount of carbonates in the seawater as compared with standard desalination processes. This enables an increase in carbon capture by the sea, reducing the carbon footprint of the plant. More specifically, the desalination process of the presently disclosed subject matter, by enabling the precipitation as disclosed above, removes carbon dioxide from seawater (and hence reduces the amount thereof) thereby facilitating carbon dioxide capture from the atmosphere.

Thus, the presently disclosed subject matter provides a number of overall benefits, including energy saving (especially in 2 pass desalination plants), cost savings, self-manufacture of the required chemicals resulting in a chemical cost saving, additional profit from selling excess chemicals and carbon capture credits with a significant reduction in total operating costs.

As illustrated in FIG. 3, the precipitation reactor 2 may also precipitate magnesium hydroxide (Mg(OH)₂) from the sea water intake. This also enhances the sustainability of the process/plant because this chemical may also be required to provide satisfactory drinking water from permeate water, in addition to calcium hydroxide. Thus, the magnesium hydroxide may be delivered to the permeate water to provide drinking water. Again, the magnesium hydroxide may be regenerated to form a magnesium-based chemical, such as magnesium oxide or magnesium hydroxide, which may be added to the permeate water, with any excess being sold for additional income.

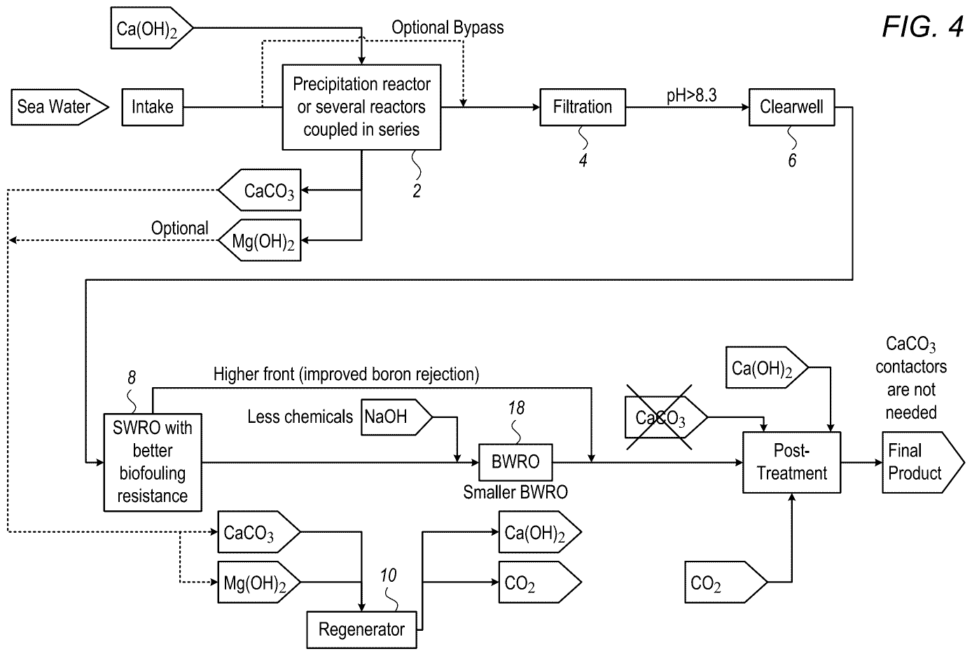

FIG. 4 of the accompanying drawings is a schematic diagram of a modified double pass SWRO system according to another embodiment of the presently disclosed subject matter. The system incorporates the same significant modification as the single pass system shown in FIG. 3, being a precipitation reactor 2 for the introduction of calcium hydroxide through which at least a proportion of the intake sea water is passed prior to delivery to a filtration unit 4 and, optionally, clearwell 6.

It is known that the front (upstream) membranes of the SWRO produce higher quality permeate (having lower salinity) than the permeate produced by the rear (downstream) membranes (having higher salinity). Several known desalination processes take advantage of the lower salinity front permeate by directing it straight to the product stream, while the higher salinity rear permeate is treated further, for example by diluting with seawater feed and recycling back through the membranes. In the presently disclosed subject matter, the introduction of calcium hydroxide raises the pH of the water to at least 8.3 or higher and precipitates out calcium carbonate (and optionally, magnesium hydroxide). This leads to the SWRO 8 operating at a higher pH providing the ability to extract more permeate flow from the front of the SWRO pressure vessels, which do not then need to pass through a BWRO stage and provides elevated pH, better biofouling resistance (namely, higher amounts of high quality permeate having lower salinity) and improved boron rejection.

This is illustrated in FIG. 4, with a portion bypassing the BWRO pass 18 while another portion of the permeate from the SWRO 8 is passed to the second pass BWRO 18 and sodium hydroxide and/or calcium hydroxide are introduced in order to elevate the pH level. The operating parameters of the first pass due to the introduction of calcium hydroxide enables the BWRO pass to be reduced in size and less chemicals have to be added to the water as the rejection of boron in the first pass is improved, as explained above. Thus, again overall operating costs are reduced.

The post treatment reactors can again be replaced with the simple addition of lime (calcium hydroxide) and carbon dioxide to form the final product without the need for calcium carbonate contactors. As with the system shown in FIG. 3, the reactor 2 may also optionally precipitate magnesium hydroxide (Mg(OH)₂) from the sea water intake which may also be delivered to the permeate water to provide drinking water. Again, the magnesium hydroxide may be regenerated to form a magnesium-based chemical, such as magnesium oxide or magnesium hydroxide, which may be added to the permeate water, thereby enhancing the sustainability of the plant.

Additionally, the calcium carbonate pellets produced as a by-product from the precipitation reactor 2 are again delivered to a regenerator 10 to produce calcium-based chemicals (such as lime and quick lime) and carbon dioxide for recycling and additional revenue streams. Thus, the incorporation of a precipitation reactor fed with calcium hydroxide also provides major advantages in a double pass system, significantly reducing the amount of chemicals used in the process and enabling a reduction in the BWRO stage size.

As mentioned above in relation to FIG. 3, the regeneration of calcium carbonate back to calcium hydroxide is provided by means of a calcinatory (kiln, burner), hydrolysis or any other methods known in the art.

In the embodiment illustrated in FIG. 4, a calcinatory 10 is again used, with the calcium carbonate being delivered to a calcinatory 10 to produce quicklime (calcium oxide) and carbon dioxide. The calcination process takes place at temperatures below the melting point of calcium carbonate (limestone), being calcined at above 400° C.; in some cases around 850° C., more preferably 1100° C. to produce calcium oxide (quicklime) and carbon dioxide. The exothermic mixing reaction of quicklime (calcium oxide) with water will result in lime (calcium hydroxide) which can be re-used and the energy released by the exothermic mixing reaction can be used to compensate some of the thermal energy used for the calcination.

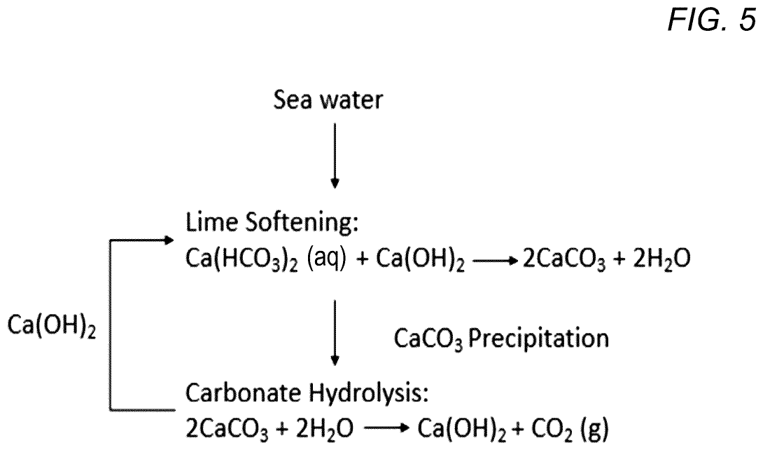

Alternatively, regeneration of calcium carbonate back to calcium hydroxide may be provided by hydrolysis. According to this embodiment, a calcium carbonate hydrolysis process may be incorporated into the process/system of the presently disclosed subject matter. This enables a lower calcination temperature of below 600° C. to be used, as illustrated in FIG. 5 of the accompanying drawings.

According to this embodiment, the hydrolysis products of calcium carbonate results in lime and carbon dioxide, according to the following equation:

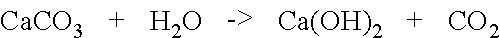

The process and system parameters of the presently disclosed subject matter can be further optimized to enhance cost and chemical savings.

The modified desalination process and plant of the present application reduces the chemical cost of the plant, increases the plant sustainability due to self-production of chemicals, reducing the carbon footprint of the plant and provides the ability to generate carbon credits as well as providing the ability to generate additional source of income by selling chemicals. In addition, the fact that the chemicals do not need to be delivered to the plant reduces the plant's carbon footprint. Moreover, with two pass systems, there is safer BWRO operation due to it operating at lower supersaturation (lower pH). The positive effect of alkalinity reduction from the brine is greater than the CO₂ emitted in the lime regeneration process.

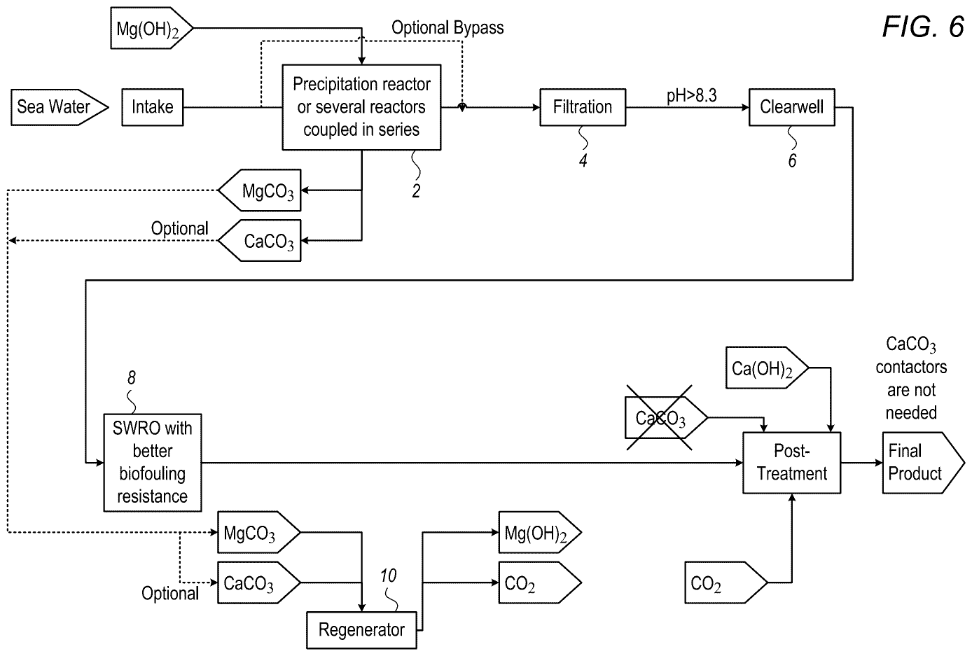

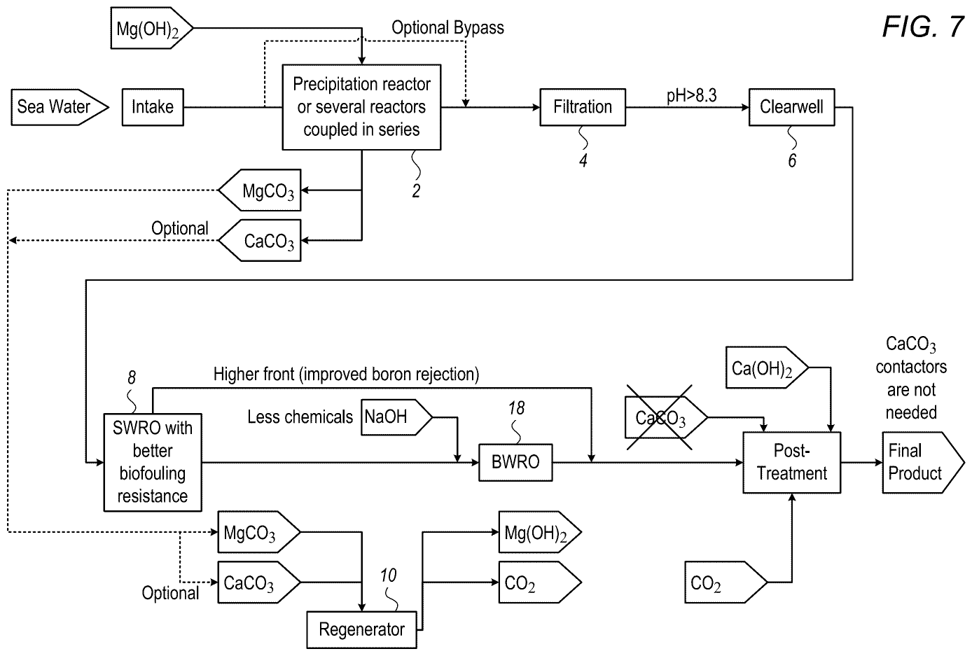

Reference is now made to FIGS. 6-7 of the accompanying drawings illustrating another embodiment of the presently disclosed subject matter. According to this embodiment, magnesium hydroxide (Mg(OH)₂), rather than or in addition to, calcium hydroxide (Ca(OH)₂) is added to reactor 2 to precipitate magnesium carbonate (MgCO₃). Identical features already discussed in relation to FIGS. 3 and 4 are provided with the same reference numerals and only the differences will be discussed in detail.

According to this embodiment of the presently disclosed subject matter input sea water is reacted with magnesium hydroxide, Mg(OH)₂) in the reactor 2 prior to its passage through the reverse osmosis passes 8 to precipitate magnesium carbonate (MgCO₃). Again the intake water may pass through a filter unit 4 and, optionally a clearwell 6, prior to its passage through the reverse osmosis passes 8. The magnesium carbonate is then subsequently regenerated in regenerator 10 (by e.g., calcination/hydrolysis, as described above with regard to the use of calcium hydroxide) for reuse in the process/plant. This provides for a series of benefits, as detailed above, in the overall cost efficiency and sustainability of the process/plant.

Thus, the reactor 2 mixes intake sea water with magnesium hydroxide to precipitate magnesium carbonate (MgCO₃) from the sea water intake which is then regenerated to form a magnesium-based chemical, such as magnesium oxide or magnesium hydroxide and carbon dioxide. Magnesium hydroxide may be added to the permeate water, thereby enhancing the sustainability of the plant; and the CO₂ is used in the post treatment process.

As outlined above, magnesium oxide (similarly to calcium oxide) could be reacted with sea water to produce magnesium hydroxide.

As seen in the figures, it is optional for calcium carbonate to also precipitate in addition to magnesium carbonate (in reactor 2). In such a case, the calcium carbonate, as detailed above, will be regenerated as well for the internal use of the plant and the desalination process (e.g., in the post treatment).

It is noted that while FIG. 6 illustrates a single pass desalination plant using a magnesium hydroxide reactor 2 equivalent to the calcium hydroxide reactor 2 of FIG. 3, FIG. 7 illustrates a double pass desalination process similar to that of FIG. 4. However, the principles of the self-sustainability of the desalination process remains the same.

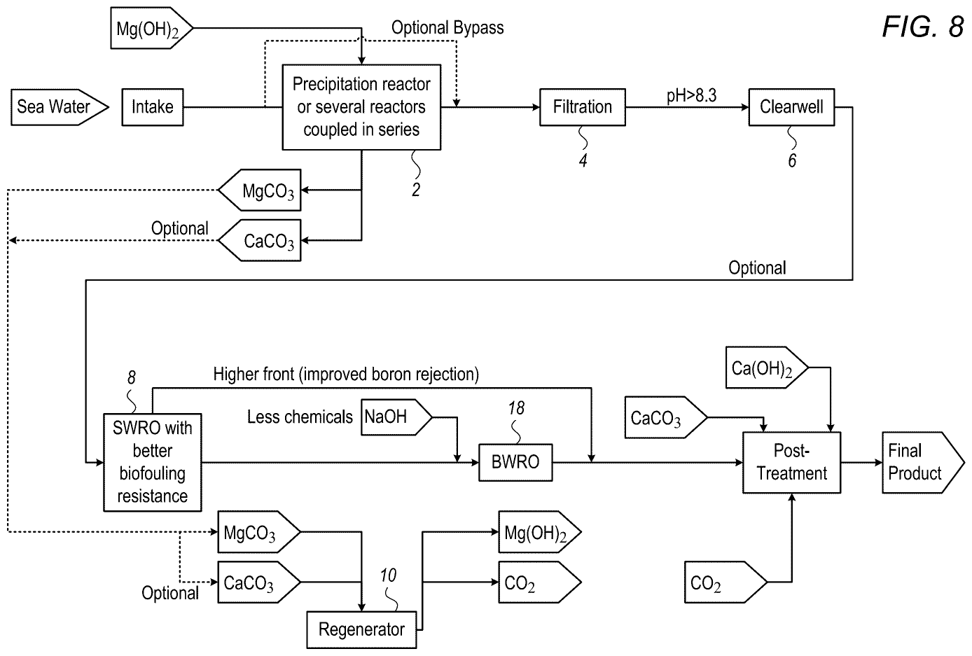

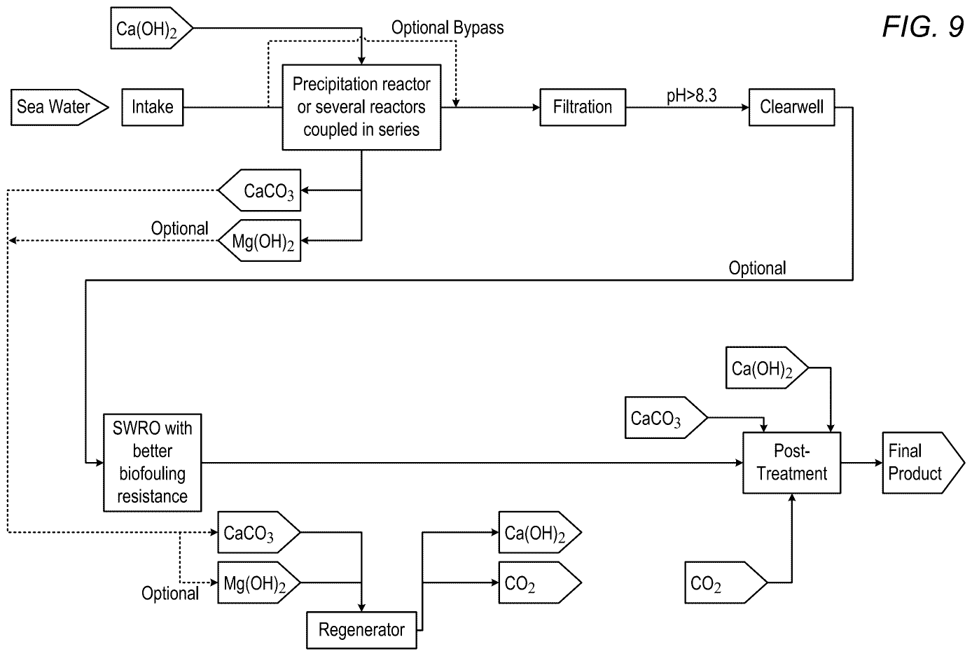

Reference is now made to FIG. 8 illustrating an embodiment substantially similar to FIG. 7 only with a difference that at least a portion of the calcium carbonate being used in the post treatment process (as an alternative to regenerating the same in the reactor).

Similarly, reference is now made to FIG. 9 illustrating an embodiment substantially similar to FIG. 3 only with a difference that at least a portion of the calcium carbonate being used in the post treatment process (as an alternative to regenerating the same in the reactor).

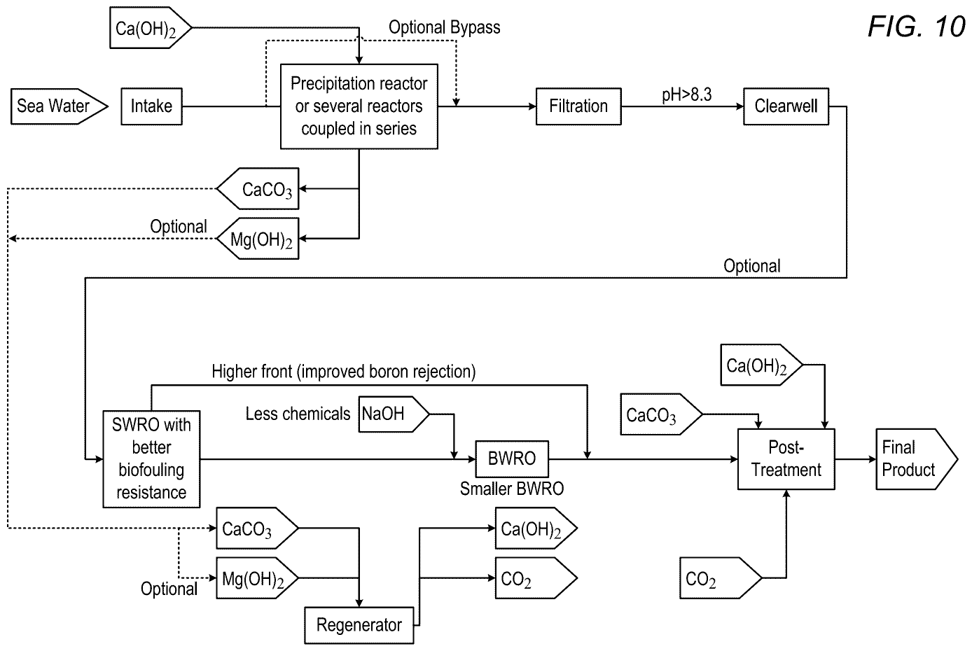

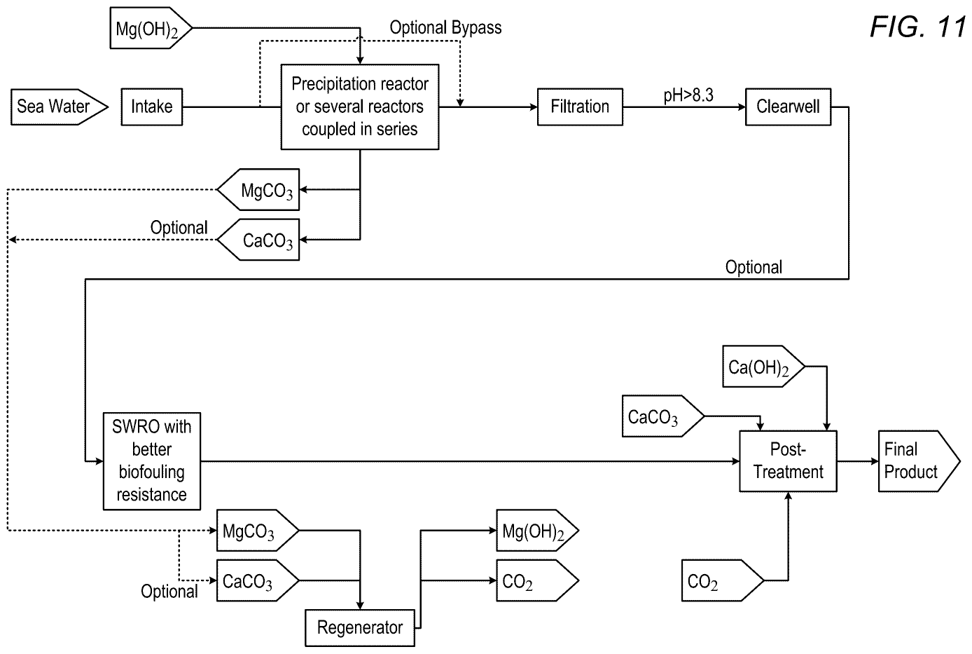

Similarly, reference is now made to FIG. 10 illustrating an embodiment substantially similar to FIG. 4 only with a difference that at least a portion of the calcium carbonate being used in the post treatment process (as an alternative to regenerating the same in the reactor).

Similarly, reference is now made to FIG. 11 illustrating an embodiment substantially similar to FIG. 6 only with a difference that at least a portion of the calcium carbonate being used in the post treatment process (as an alternative to regenerating the same in the reactor).

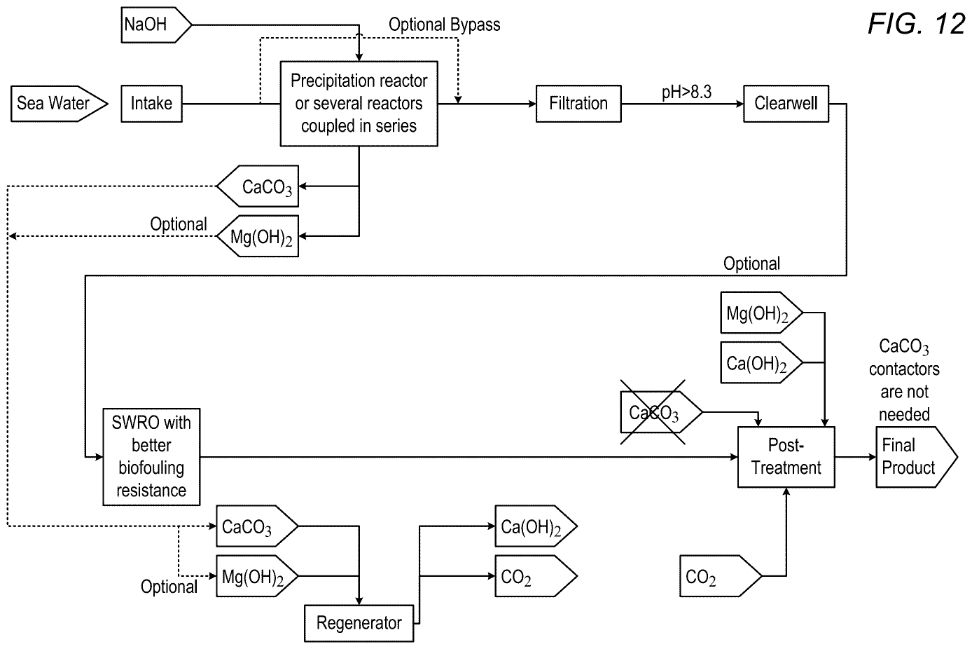

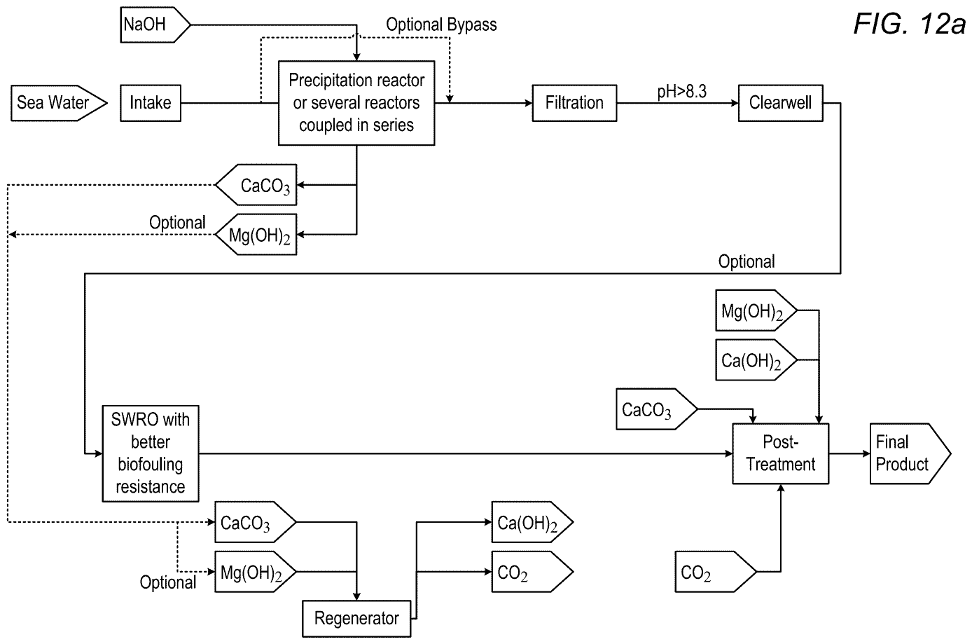

Reference is now made to FIGS. 12-12a illustrating an embodiment essentially equivalent to the embodiment of FIG. 3 (or 9) in which the precipitation reactor 2 containing or is introduced with NaOH to precipitate Calcium-based chemicals, e.g., CaCO₃, according to the following:

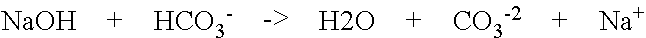

As the intake fluid (e.g., seawater) contains calcium the CO₃⁻² will react therewith to precipitate Calcium carbonate according to the following:

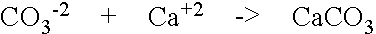

According to one embodiment, the NaOH will be provided by e.g., reaction of NaCl with water according to the following:

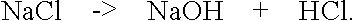

(such reaction could be enabled by means of e.g., bipolar membranes).

While the NaOH could be used as disclosed above (for the precipitation of the CaCO₃), the HCl could be sold to any 3^{rd} party.

While FIG. 12 illustrates an embodiment where CaCO₃ is not required in the post treatment, FIG. 12a illustrates an embodiment where at least a portion of the CaCO₃ is used in the post treatment.

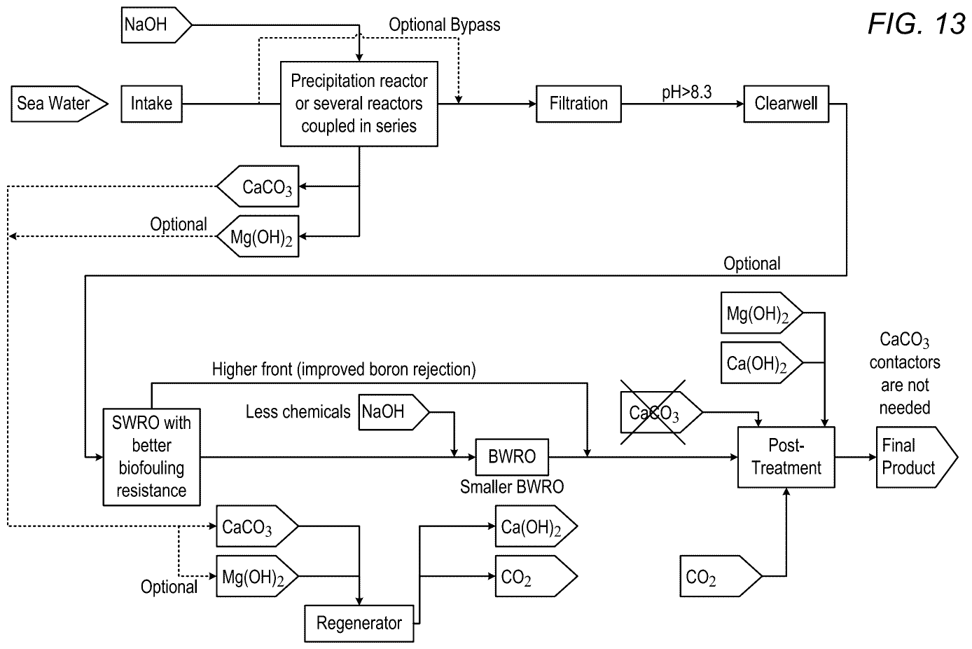

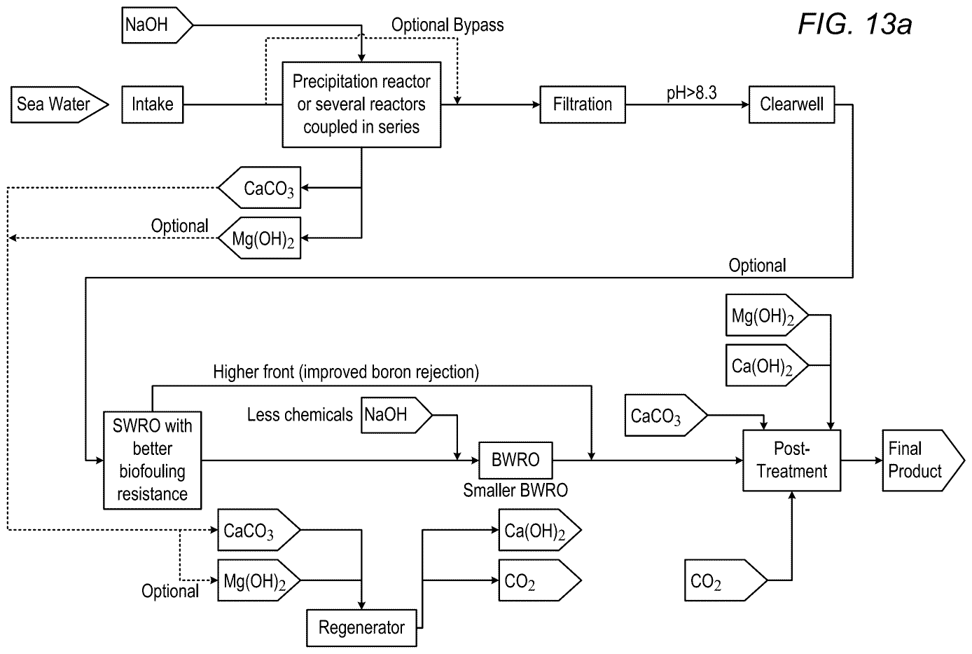

Reference is now made to FIGS. 13-13a illustrating an embodiment essentially equivalent to the embodiment of FIG. 4 (or 10) in which the precipitation reactor 2 containing or is introduced with NaOH to precipitate Calcium-based chemicals, as disclosed above.

While FIG. 13 illustrates an embodiment where CaCO₃ is not required in the post treatment, FIG. 13a illustrates an embodiment where at least a portion of the CaCO₃ is used in the post treatment.

It should be noted that in all the above embodiments, magnesium-based chemicals could be added in the post treatment (e.g., MgOH).

It is to be appreciated that modifications to the aforementioned process and systems may be made without departing from the principles embodied in the examples described and illustrated herein.

1. A process for the desalination of sea water, the process comprising:
feeding at least a portion of intake sea water through at least one reactor for the removal of carbonates-based chemical; and
filtrating said intake sea water.

2. The process according to claim 1, wherein said step of filtrating comprising desalinating said intake sea water to produce permeate product water and brine.

3. The process according to claim 1, wherein said step of filtrating comprising at least one process selected from a group consisting of reverse osmosis, forward osmosis, pressure-retarded osmosis, ultrafiltration, microfiltration and nanofiltration any combination thereof.

4. The process according to claim 1, wherein the reactor containing therein or is introduced with at least one selected from a group consisting calcium hydroxide (Ca(OH)₂), NaOH and any combination thereof to precipitate at least one carbonates-based chemical selected from a group consisting of calcium carbonate (CaCO₃).

5. (canceled)

6. (canceled)

7. The process according to claim 1, wherein feeding at least a portion of intake sea water through at least one reactor containing calcium hydroxide (Ca(OH)₂) increases the pH of the intake water to at least pH 8.3.

8. (canceled)

9. The process according to claim 1, further comprising the step of regenerating at least some of the calcium carbonate precipitant to a calcium-based chemical and carbon dioxide.

10. The process according to claim 9, wherein the calcium-based chemical is selected from a group consisting of calcium hydroxide or calcium oxide and any combination thereof.

11. The process according to any Ge of claims 9-19, wherein regenerating the calcium carbonate to the calcium-based chemical comprises a method selected from at least one of calcinating the precipitated calcium carbonate, hydrolysing the precipitated calcium carbonate and any combination thereof.

12. The process according to claim 11, wherein regenerating the calcium carbonate comprises calcination comprising heating the calcium carbonate to a temperature of at least 500° C.

13. The process according to claim 11, wherein regenerating the calcium carbonate comprises hydrolysing the calcium carbonate to produce at least one selected from the group consisting of calcium hydroxide, calcium oxide, carbon dioxide and any combination thereof.

14. (canceled)

15. The process according to claim 13, wherein the calcium-based chemical is calcium oxide and the process further comprises mixing at least a portion of the calcium oxide with at least a portion of intake sea water to form calcium hydroxide.

16. The process according to claim 10, wherein at least a portion of the calcium hydroxide formed by regeneration of the calcium carbonate is at least one selected from (a) recycled for use in the at least one reactor; (b) used in the post treatment process; (c) any combination thereof.

17. The process according to claim 1, wherein additionally comprising at least one step selected from a group consisting of (a) feeding at least a portion of intake sea water through the at least one reactor containing calcium hydroxide (Ca(OH)₂) also precipitates magnesium hydroxide; (b) feeding at least a portion of intake sea water through the at least one second reactor adapted to precipitate magnesium-based chemical selected from a group consisting of magnesium hydroxide, magnesium oxide and any combination thereof; and any combination thereof.

18. The process according to claim 17, further comprising the step of regenerating at least some of the magnesium hydroxide precipitant to a magnesium-based chemical.

19. The process according to claim 18, further comprising adding at least a portion of the regenerated magnesium-based chemical to the permeate to produce product water.

20. The process according to claim 1, wherein feeding at least a portion of intake sea water through the at least one reactor containing calcium hydroxide (Ca(OH)₂) also precipitates magnesium hydroxide; and the process further comprises the steps of (i) regenerating at least some of the calcium carbonate and magnesium hydroxide precipitants to produce a calcium-based chemical, a magnesium-based chemical and carbon dioxide; and, (ii) mixing at least some of the regenerated chemicals and carbon dioxide with the permeate product water to produce drinking water.

21. The process according to claim 1, wherein only a portion of the sea water is fed through the reactor with the remaining intake sea water bypassing the at least one reactor.

22. The process according to claim 21, further comprising step of mixing said portion of the sea water fed through the at least one reactor with the remaining intake sea water bypassing the at least one reactor.

23. (canceled)

24. (canceled)

25. (canceled)

26. (canceled)

27. The process according to any one of claim 1, wherein at least one of the following is held true (a) the process excludes calcium carbonate contactor in the post-treatment of the permeate water, (b) at least a portion of the calcium carbonate, (CaCO₂), is used in the post treatments of the ter post the desalination step; and any combination thereof.

28. (canceled)

29. (canceled)

30. A filtration system comprising:
at least one conduit for delivering at least a portion of an intake sea water to the at least one reactor for the removal of carbonates-based chemical; and
at least one filtrating module; wherein at least a portion of the intake sea water is delivered through the at least one reactor prior to being delivered through the filtrating module.

31. The filtration system as claimed in claim 30, wherein said at least one filtrating module is reverse osmosis pass comprising at least one reverse osmosis membrane; further wherein at least a portion of the intake sea water is delivered through the at least one reactor prior to being delivered through the pass to produce permeate product water and brine.

32. The filtration system as claimed in claim 30, wherein said at least one filtrating module comprising at least one process selected from a group consisting of reverse osmosis, forward osmosis, pressure-retarded osmosis, ultrafiltration, microfiltration and nanofiltration any combination thereof.

33. The filtration system as claimed in claim 30, wherein said at least one reactor having at least one calcium hydroxide (Ca(OH)₂), NaOH and any combination thereof source to precipitate at least one carbonates-based chemical selected from a group consisting of calcium carbonate (CaCO₃).

34. (canceled)

35. The filtration system as claimed in claim 30, wherein at least one regeneration module is provided to convert at least some of the calcium carbonate precipitant to a calcium-based chemical and carbon dioxide.

36. The filtration system as claimed in claim 30, wherein said at least one regeneration module is selected from at least one of a calcinatory, a hydrolysis reactor and any combination thereof.

37. The filtration system according to claim 36, wherein said at least one regeneration module is a calcinatory provided for calcinating the precipitated calcium carbonate to produce at least one of calcium hydroxide, calcium oxide, carbon dioxide and any combination thereof.

38. (canceled)

39. The filtration system as claimed in claim 30, wherein the at least one regeneration module comprises at least one hydrolysis reactor for hydrolysing the calcium carbonate to produce at least one selected from a group consisting of calcium hydroxide (Ca(OH)₂), calcium oxide (CaO), carbon dioxide (CO₂) and any combination thereof.

40. (canceled)

41. (canceled)

42. The filtration system as claimed in claim 30, wherein at least one pipe is provided to deliver at least one, preferably both, of a portion of the calcium-based chemical and carbon dioxide formed by the regeneration module to the permeate produced by the at least one reverse osmosis membrane to produce the product water.

43. (canceled)

44. (canceled)

45. (canceled)

46. The filtration system as claimed in claim 30, wherein the at least one reactor having a calcium hydroxide (Ca(OH)₂) source also precipitates magnesium hydroxide; and, the system includes at least one regeneration module regenerating at least some of the calcium carbonate and magnesium hydroxide precipitants to produce a calcium-based chemical, a magnesium-based chemical and carbon dioxide and piping to deliver at least some of the regenerated chemicals and carbon dioxide to the permeate product water to produce drinking water.

47. The filtration system as claimed in claim 30, wherein a bypass is provided between the intake sea water and the reverse osmosis pass to enable the delivery of a portion of the sea water through the at least one reactor with the remaining intake sea water bypassing the at least one reactor.

48. (canceled)

49. The filtration system as claimed in claim 30, wherein the at least one reactor is a fluidized bed reactor.

50. (canceled)

51. (canceled)

52. The filtration system as claimed in claim 30, wherein at least a portion of the intake sea water delivered through the at least one reactor results in an increase in pH of the at least a portion of the intake water to a pH of at least 8.3, wherein said increases in pH to at least 8.3 of at least a portion of the intake sea water enhances boron rejection by said at least one reverse osmosis membrane to thereby increase the overall efficiency of the desalination system.

53. (canceled)

54. The filtration system as claimed in claim 30, wherein at least one of the following is being held true (a) a portion of the calcium carbonate, (CaCO₃), is used in the post treatments of the permeate water post the desalination step, (b) at least a portion of the magnesium-based is used in the post treatments of the parameter water post the desalination step, (c) any combination thereof.

55. (canceled)

56. A self-sustainable desalination process for the desalination of sea water, the process comprising:
delivering sea water to an intake pipe;
carbonates-based chemical removing from said sea water;
delivering under pressure all the intake water to at least one pass comprising at least one reverse osmosis membrane to produce permeate and brine.

57. The self-sustainable desalination process according to claim 56, wherein said carbonates-based chemical removing is performed by introducing calcium hydroxide (Ca(OH)₂) into at least one reactor; and passing at least a portion of the intake sea water through the reactor to precipitate at least calcium carbonate (CaCO₃) from the sea water.

58. The self-sustainable desalination process according to claim 52, additionally comprising step of regenerating at least one selected from the group consisting of calcium hydroxide (Ca(OH)₂), calcium oxide (CaO), carbon dioxide (CO₂), magnesium hydroxide (Mg(OH)₂) and any combination thereof.

59. The self-sustainable desalination process according to claim 54, wherein said step of regenerating at least one selected from the group consisting of calcium hydroxide (Ca(OH)₂), calcium oxide (CaO), carbon dioxide (CO₂), magnesium hydroxide (Mg(OH)₂) and any combination thereof from said carbonates-based chemical.

60. The self-sustainable desalination process according to claim 56, additionally comprising step of adding at least a portion of at least one of the calcium hydroxide (Ca(OH)₂), calcium oxide (CaO) and carbon dioxide (CO₂) and any combination thereof regenerated from the calcium carbonate (CaCO₃) precipitant to at least one of (i) the permeate to produce product water and (ii) the at least one reactor, and any combination thereof.

61. A self-sustainable desalination system for the desalination of sea water, the system comprising:
a sea water intake;
at least one reactor having a calcium hydroxide (Ca(OH)₂) source;
at least one conduit for delivering at least a portion of the sea water from the intake to the at least one reactor to precipitate calcium carbonate (CaCO₃);
at least one reverse osmosis pass comprising at least one reverse osmosis membrane, wherein all the intake sea water is delivered through the pass to produce permeate and brine;
at least one regeneration module to convert at least some of the calcium carbonate (CaCO₃) precipitant to at least one selected from a group consisting of calcium hydroxide (Ca(OH)₂), calcium oxide (CaO), carbon dioxide (CO₂) and any combination thereof; and
a recycling system to deliver at least a portion of at least one of the calcium hydroxide (Ca(OH)₂), calcium oxide (CaO) and carbon dioxide (CO₂) and any combination thereof regenerated from the calcium carbonate (CaCO₃) precipitant to at least one of (i) the permeate to produce product water and (ii) the at least one reactor and any combination thereof.

62. (canceled)

63. (canceled)

64. (canceled)

65. (canceled)

66. (canceled)

67. (canceled)

68. (canceled)

69. (canceled)

70. (canceled)

71. The self-sustainable desalination process according to claim 56, wherein said step of regenerating at least some of the calcium carbonate precipitant comprises a method selected from at least one of calcinating the precipitated calcium carbonate, hydrolysing the precipitated calcium carbonate and any combination thereof.

72. The self-sustainable desalination process according to claim 71, wherein said step of regenerating at least some of the calcium carbonate precipitant results in calcium-based chemical selected from a group consisting of calcium hydroxide or calcium oxide and any combination thereof.

73. The self-sustainable desalination system according to claim 61, wherein said at least one regeneration module is selected from at least one of calcinator, hydrolysing module and any combination thereof.

74. The self-sustainable desalination system according to claim 63, wherein said at least one regeneration module results in calcium-based chemical selected from a group consisting of calcium hydroxide or calcium oxide and any combination thereof.
